(19) United States
(12) Patent Application Publication
(10) Pub. No.: US 2010/0180213 A1
(43) Pub. Date: Jul. 15, 2010

(54) DOCUMENT CREATION SYSTEM AND METHODS

(75) Inventors: Evangelos Karageorgos, Xanthi (GR); Stavros Kounis, Xanthi (GR); Pavlos Moustakidis, Veria (GR); John D. Pavlidis, Los Altos, CA (US); Ioannis Katsavounidis, Los Angeles, CA (US)

Correspondence Address: BRIAN J. DAIUTO;LAW OFFICE OF BRIAN J. DAIUTO, 886 ILIMA COURT, PALO ALTO, CA, 94306, US

(73) Assignee: SCIGEN TECHNOLOGIES, S.A., Xanthi (GR)

(21) Appl. No.: 12/621,368

(22) Filed: Nov. 18, 2009

Related U.S. Application Data
(60) Provisional application No. 61/116,153, filed on Nov. 19, 2008.

(51) Int. Cl. G06F 3/048; G06F 17/30

(52) U.S. Cl. 715/753; 707/709; 715/810; 715/771; 707/705; 707/802; 707/E17.044; 707/E17.108; 715/764

(57) ABSTRACT

Methods, systems, and related computer program products for facilitating the generation of a document, such as a scientific poster, to be viewed by a community of human viewers in association with a hosted event, such as a scientific conference, are described, the generated document conforming to document configuration guidelines previously established for that hosted event. Provided in one preferred embodiment is an interactive document creation tool that constrains user input of content data according to constraints specified in the document configuration guidelines and then automatically generates the document from the content data in compliance with those document configuration guidelines, sparing substantial user time and effort particularly when a pre-existing antecedent electronic document is used as a basis for the content data. Also provided are methods for coordinating document display at hosted events, managing populations of distinct document configuration guidelines, and adapting a created document for multiple different hosted events.

### CROSS-REFERENCE TO RELATED APPLICATIONS

This application claims the benefit of U.S. provisional patent application Ser. No. 61/116,153, filed Nov. 19, 2008, entitled “Scientific Poster Creation System And Methods,” which is incorporated by reference herein.

The subject matter of the instant application is related to the subject matter of the commonly assigned PCT International Patent Application Number PCT/US09/64982, which was filed on the same day as the instant application, and which is incorporated by reference herein.

### FIELD

This patent specification relates to interactive computerized document creation and management. More particularly, this patent specification relates to a computerized tool for facilitating the generation of a document, such as a scientific poster, to be viewed by a community of human viewers in association with a hosted event, such as a scientific conference, according to document configuration guidelines established for the hosted event, and further relates to computerized methods for coordinating document display at hosted events as well as the management of document configuration guidelines associated with various different hosted events.

### BACKGROUND

It is often the case that a person desires to create a document that is to be viewed by an interested community of viewers at a hosted event, the document being required to comply with certain document configuration guidelines, such as those that might be set forth by an organizer of the hosted event. The document configuration guidelines typically set forth rules, suggestions, conventions, and/or standards for how the document is to be configured. By way of example, a scientific researcher may desire to create a scientific poster that is to be displayed at a scientific conference. In such case, the organizer of the scientific conference may set forth scientific poster configuration guidelines dictating various constraints that are to be met by the displayed posters, such as: content type (the type of content that may be permissibly displayed on the poster, such as the kinds of charts and images that are allowed for printed posters, or the kinds of digital videos or interactive windows that are allowed for electronic posters, and so forth); content section constraints (required logical groupings for the displayed information and/or the associated headings that are to be used, such as “Introduction,” “Methods,” “Results,” “Conclusions,” “References,” “Government Funding Disclosure,” “Hazardous Materials Disclosure,” and so forth); content section sequence (the required sequence of the content sections), content spatial layout (rules such as poster size, section size, section placement, and so forth); and content formatting (rules regarding text styles, text spacing, text justification, background style, and so forth).

When creating such documents to conform with such document configuration guidelines using known prior art computing tools, and/or when managing the created document for display at the hosted event, the user encounters one or more problems and/or substantial inefficiencies that are at least partially addressed by one or more of the preferred embodiments described infra in the instant patent specification. While certain problems and inefficiencies associated with known prior art computing tools are described here in the particular context of scientific poster creation for display at scientific conferences, they are representative of the kinds of problems and inefficiencies that arise in the creation of many different kinds of documents according to known prior art methods.

Generally speaking, it is often the case that the scientific researcher has created, or otherwise has access to, a previously authored document in electronic form, termed herein an antecedent document, that sets forth the particular scientific subject matter that will be expressed on the poster. The antecedent document usually sets forth the subject matter to a substantially different level of detail that is required for the poster, and expresses the content data in a substantially different configuration than is needed for the scientific poster. By way of example, the antecedent document is often a journal article stored in its original format, such as MICROSOFT® WORD® or COREL® WORDPERFECT®. However, even though there may already exist an antecedent document in electronic form, there are problems and inefficiencies associated with known prior art methods in progressing therefrom to the desired guideline-conformant poster.

In one prior art scenario, the poster author creates the poster using conventional general-purpose software originally created for on-screen presentation preparation or document preparation, such as MICROSOFT® WORD®, COREL®WORDPERFECT®, MICROSOFT® VISIO®, MICROSOFT® POWERPOINT®, or COREL® CORELDRAW®, to name a few. For the case of events, like scientific conferences, there are specific guidelines regarding the size, appearance and format as well as the content structure of each poster. Consequently, the poster author needs to carefully read through conference guidelines and, based on them, define all parameters of the poster, such as size, poster orientation and page margins. As a second step, the poster author needs to manually create and arrange text and image placeholder boxes one-by-one, insert and arrange text, images and graphs, choose suitable colors and background graphics and adjust font size as well as other typographic parameters, such as line-heights and paragraph spaces. Lastly and importantly, the poster author needs to fit their content to the available poster surface, hoping that it will be readable, as well as aesthetically presentable, when printed or displayed. For posters to be printed, poster authors can either take their work to a professional print-shop or use their own printing equipment, such as an inkjet or laser printer, to transfer their work onto paper. Upon printing, the poster author is in possession of a physical printed copy which they have to carry to the scientific conference. As a result of the above, the poster author needs to constantly change focus from the poster content to the poster design, all the way during the process. For the poster author, this results in loss of time, that can vary from hours to days depending on one's experience. Additionally, it forces the poster author to spend effort and creativity on dealing with the design and layout of the poster, with aesthetically dubious results, rather than focusing on the actual content of the poster.

In a second prior art scenario, the poster author may choose to appoint the design and arrangement of the poster to a professional graphic designer. In this scenario, the poster author needs to deliver the selected content to the graphic designer well in advance of any pending deadlines. Then, the poster author can choose among a limited number of sample designs included in the graphic designer's portfolio. As a next step, the graphic designer uses their complex, expensive, general-purpose graphics software applications to create a first version of the actual poster. The poster author and graphic designer have to review this version and any subsequent versions together to make necessary changes, and interact closely all the way through the process, until a final version of the poster design is accomplished. Only after this iterative and time-consuming proofreading and adjustment process is the poster author finally in possession of the final printed copy, which they then have to physically carry to the scientific conference. Due to the graphic designer's time spent as well as the quality of the poster design, this method usually entails a very high cost, and yet still entails the investment of substantial time by the poster author. Other issues arise as would be apparent to one skilled in the art in view of the present disclosure.

### SUMMARY

Methods, systems, and related computer program products are provided for facilitating the generation of a document, such as a scientific poster, to be viewed by a community of human viewers in association with a hosted event, such as a scientific conference, the generated document conforming to document configuration guidelines previously established for that hosted event. Provided in one preferred embodiment is an interactive, intuitively understood, user-friendly document creation tool that constrains user input of content data according to constraints specified in the document configuration guidelines and then automatically generates the document from the content data in compliance with those document configuration guidelines, sparing substantial user time and effort particularly when a pre-existing antecedent electronic document is used as a basis for the content data. Also provided are methods, systems, and related computer program products for coordinating document display at hosted events, managing populations of distinct document configuration guidelines, and adapting created documents for multiple different hosted events.

In one preferred embodiment, provided is the computer-assisted generation of a document to be viewed by a community of human viewers in association with a hosted event, the generated document satisfying a set of document configuration guidelines previously established for that hosted event. A population of hosted events in association with which documents are to be viewed by a respective community of human viewers is identified, each hosted event having associated therewith a defined set of document configuration guidelines as set forth in a prepared guidelines document. For each identified hosted event, the associated prepared guidelines document is accessed and processed to generate therefrom a document configuration rules information object. The document configuration rules information object for each of the population of identified hosted events conforms to a common document configuration rules format. A document configuration rules database is formed that includes the information from each of the document configuration rules information objects. A computerized interactive document generation tool is provided to a user, the document generation tool processing user-pasted or otherwise user-identified content data to generate a digital document therefrom. In operation, the document generation tool displays to the user a plurality of event identifiers corresponding to respective ones of the hosted events, receives from the user a selection of one of the event identifiers corresponding to a selected hosted event for which document generation is desired, accesses from the document configuration rules database the document configuration rules information object corresponding to the selected hosted event, and automatically processes the content data to generate therefrom the digital document according to the document configuration rules information object such that a configuration of the digital document is in conformance with the defined set of document configuration guidelines for the selected hosted event.

According to another preferred embodiment, provided is the computer-assisted generation of a document, the document to be viewed by human viewers. A plurality of document configuration guideline identifiers corresponding to a respective plurality of predefined document configuration guidelines is displayed to a user. A selection of one of the document configuration guideline identifiers is received from the user to thereby identify a selected one of the predefined document configuration guidelines. User-pasted or otherwise user-identified content data upon which the document is to be based is received from the user, the content data comprising at least one digital media gallery and at least one text segment. An identified set of bounded regions within which the content data is to be spatially distributed on the document is received from the user. A minimum document viewing distance parameter is established by virtue of one of user input, the selected predefined document configuration guidelines, and a default minimum document viewing distance parameter. The content data is automatically processed to generate therefrom the document in digital form. In the automated processing, the text of the at least one text segment is sized such that the text is readable at the established minimum viewing distance, the text section is fully spatially contained within the identified set of bounded regions, and the selected predefined document configuration guidelines are otherwise met. Also in the automated processing, the at least one digital media gallery is spatially sized to occupy as large a spatial area as possible on the document while also being constrained to one of the identified set of bounded regions, constrained within that bounded region to accommodate any of the text segment identified to be positioned in that bounded region, and (iii) constrained such that the selected predefined document configuration guidelines are otherwise met.

According to another preferred embodiment, provided is the computer-assisted generation of a document, the document to be displayed to a population of human viewers at different viewing distances including a first viewing distance interval. User-pasted or otherwise user-identified content data upon which the document is to be based is received from a user, the content data including at least one text segment. Based at least in part upon at least one of user input and a selected predefined document configuration guideline, a spatial area of the document to be created is established. The content data is then automatically processing to generate therefrom the document in digital form. The automated processing includes automatically determining a font size for the at least one text segment such that the content data is spatially contained within the established document area while conformance of the document with the predefined document configuration guideline is maintained. A user interface tool is provided that receives optional user adjustments affecting the font size to thereby establish a current font size for the digital document. Upon the establishment of the current font size, an optimal document viewing distance is automatically determined in real time based on the current font size. The automatically determined optimal document viewing distance is displayed to the user in real time in conjunction with a real time indicator identifying whether the automatically determined optimal viewing distance falls within a predetermined first viewing distance range.

According to another preferred embodiment, provided is a hosting server that facilitates the hosting of a hosted event at which a plurality of electronic media items are to be displayed in a respective plurality of electronic media item presentation sessions, each electronic media item presentation session to take place at one of a plurality of distinct media presentation stations provided in association with the hosted event. Each of the plurality of electronic media items to be displayed is received and stored. Scheduling information is received indicating, for each of the electronic media item presentation sessions, a designated time interval therefor and a designated one of the media presentation stations at which the associated electronic media item is to be displayed. For each of the electronic media item presentation sessions, the hosting server causing the associated electronic media item to be displayed at the designated media presentation station during the designated time interval.

According to another preferred embodiment, provided is the computer-assisted generation of a poster by a computing device that includes a computerized user interface having a clipboard feature, the poster to be viewed by a community of human viewers in association with a hosted conference, the poster to be based at least in part on information contained in an antecedent electronic document from which blocks of information are to be pasted into the poster. The antecedent electronic document includes (a) a first data block listing a plurality of author names, (b) a second data block listing a plurality of affiliations, (c) a plurality of intermediate characters not part of author names or affiliation names distributed among the first and second data blocks from which can be identified associations among the authors and the affiliations. The poster is to conform to poster configuration guidelines previously established for that hosted conference in which the plurality of author names and affiliations are to be visually expressed in a different configuration than as provided in the first and second data blocks of the antecedent electronic document. Displayed to a user is a first paste control that at least partially keys the user to access the antecedent electronic document and to copy the first data block into a clipboard. Upon user selection of the first paste control, the first data block is received from the clipboard and processed to distinctively identify therefrom the plurality of author names. Displayed to the user a second paste control that at least partially keys the user to access the antecedent electronic document and to copy the second data block into the clipboard. Upon user selection of the second paste control, the second data block is received from the clipboard and processed to distinctively identify therefrom the plurality of affiliations, and the first data block and the second data block, including the intermediate characters, are jointly processed to distinctively identify therefrom the association, if any, between each distinctively identified author name and each distinctively identified affiliation. A visual expression of the author names and affiliations for inclusion in the poster is then automatically computed according to the poster configuration guidelines based on the distinctively identified author names, the distinctively identified affiliations, and the distinctively identified author-affiliation associations.

According to another preferred embodiment, provided is the computer-assisted generation of a poster to be viewed by a community of human viewers in association with a hosted event, the poster satisfying a poster configuration guideline previously established for that hosted event. A poster configuration rules database is provided that includes a plurality of poster configuration rules information objects corresponding respectively to a population of hosted events. Each poster configuration rules information object is based upon a respective one of the poster configuration guidelines, and all of the poster configuration rules information objects conform to a common poster configuration rules format. Each poster configuration rules information object governs the corresponding poster to be generated according to content type, content section constraints, content section sequence, content spatial layout, and content formatting. An identity of the hosted event for which it is desired that a poster be generated is received from a user. A poster configuration rules information object corresponding to the identified hosted event is accessed from the poster configuration rules database. Displayed to the user is a plurality of content section input frames corresponding to a respective plurality of content sections specified by the content section constraints of the poster configuration rules information object, the plurality of content section input frames being sequenced according to the content section sequence of the poster configuration rules information object. Blocks of user-pasted or otherwise user-identified content data are received into respective ones of the content section input frames, the respective blocks of content data each including at least one media object and least one text segment. The received content data is then automatically processed to generate therefrom the poster according to the content type, content section constraints, content section sequence, content spatial layout, and content formatting specified in the poster configuration rules information object. Responsive to a first user request, the poster is rendered in real time and a viewable version thereof is displayed in a manner scaled to fit onto a predefined display area. Responsive to a second user request, the content data is automatically reformatted to facilitate a guided user navigation through the poster content on at least one of a section-by-section basis and media object-by-media object basis. Responsive to a third user request, the content data is automatically reformatted to generate therefrom a small-scale version of the poster content suitable for printout and distribution to the community of human viewers.

According to another preferred embodiment, provided is the computer-assisted generation of a plurality of documents to be viewed by respective communities of human viewers in association with a respective plurality of hosted events, each document satisfying a respective document configuration guideline previously established for the respective plurality of hosted events. A document configuration rules database is provided that includes a plurality of document configuration rules information objects corresponding respectively to the plurality of hosted events. Each document configuration rules information object is based upon a respective one of the document configuration guidelines and conforms to a common document configuration rules format. Each document configuration rules information object governs the corresponding document to be generated according to content type, content section constraints, content section sequence, content spatial layout, and content formatting. An identity of a first hosted event for which it is desired that a first document be generated is received from a user. A first document configuration rules information object corresponding to the first identified hosted event is accessed from the document configuration rules database. Displayed to the user is a plurality of content section input frames is corresponding to a respective plurality of content sections specified by the content section constraints of the first document configuration rules information object, the plurality of content section input frames being sequenced according to the content section sequence of the first document configuration rules information object. Blocks of user-pasted or otherwise user-identified content data are received into respective ones of the content section input frames, the respective blocks of content data each including at least one media object and at least one text segment. The received content data is then automatically processed to generate therefrom the first document according to the content type, content section constraints, content section sequence, content spatial layout, and content formatting specified in the document configuration rules information object. The first document is stored. An identity of a second hosted event for which it is desired that a second document be generated is received from the user. A second document configuration rules information object corresponding to the second identified hosted event is accessed from the document configuration rules database. The first document is retrieved and automatically processed to generate therefrom the second document according to the content type, content section constraints, content section sequence, content spatial layout, and content formatting specified in the second document configuration rules information object, thereby saving a substantial amount of user time and effort in creating the second document.

### BRIEF DESCRIPTION OF THE DRAWINGS

FIG. 1 illustrates an example of a scientific poster;

FIG. 2 illustrates examples of prepared guidelines documents for the generation of scientific posters;

FIG. 3 illustrates a scientific poster generation, distribution, management, and display environment including a poster generation tool, a poster configuration rules processing server, and a plurality of conference hosting servers according to one or more of the preferred embodiments;

FIG. 4A-4D illustrates a poster configuration rules information object according to a preferred embodiment;

FIG. 5A illustrates an example view of a welcome screen of a poster generation tool according to a preferred embodiment;

FIG. 5B illustrates an example view of a step of a wizard-based process provided by a poster generation tool according to a preferred embodiment in which an event name is identified and poster dimensions are established;

FIG. 5C illustrates an example view of a user interface associated automated identifications of authors, affiliations, and associations thereamong according to a preferred embodiment;

FIG. 5D illustrates a conceptual view of automated identifications of authors, affiliations, and associations there among according to a preferred embodiment;

FIG. 5E illustrates an example view of a step of a wizard-based process provided by a poster generation tool according to a preferred embodiment in which the user may defined the poster's section structure;

FIG. 6 illustrates an example view of a step of a wizard-based process provided by a poster generation tool according to a preferred embodiment in which the user may choose the design and layout of the poster from among of a library of templates;

FIG. 7 illustrates an example view of a user interface screen associated with the template selection step of FIG. 6;

FIG. 8 illustrates a user interface screen of a poster generation tool that provides a constrained content input environment according to a preferred embodiment;

FIG. 9 illustrates an example view of options by which the user may copy and paste content from or into the poster being generated using a poster generation tool according to a preferred embodiment;

FIG. 10 illustrates an example view of a user interface that provides multiple options for the user to arrange, resize, and provide captions for multiple media objects in a poster generation tool according to a preferred embodiment;

FIG. 11 illustrates an example view of some of the layouts that groups of objects may be arranged into in a poster generation tool according to a preferred embodiment;

FIG. 12 illustrates an example view of a method utilized for the calculation of object width or object group width as a function of column width in a poster generation tool according to a preferred embodiment;

FIG. 13 illustrates determining a column width as a function of the number of columns, as well as margins and padding of the poster layout in a poster generation tool according to a preferred embodiment;

FIG. 14 illustrates an example view of a method of calculating positioning and alignment of object legend text underneath its corresponding object in a single column gallery layout case in a poster generation tool according to a preferred embodiment;

FIG. 15 illustrates an example view of a method of calculating positioning and alignment of object legend text underneath its corresponding object in a two-column gallery layout case in a poster generation tool according to a preferred embodiment;

FIG. 16 illustrates an example view of a method of calculating positioning and alignment of object legend text underneath its corresponding object in a two-column gallery layout case in a poster generation tool according to a preferred embodiment;

FIG. 17 illustrates variable definitions associated with the positioning and alignment calculations of FIGS. 14-16;

FIG. 18 illustrates an example view of advanced section adjustment options in a poster generation tool according to a preferred embodiment;

FIG. 19 illustrates an example view of the workspace layout arranged to best fit and show a poster with landscape orientation in a poster generation tool according to a preferred embodiment;

FIG. 20 illustrates an example view of a workspace layout arranged to best fit and show a poster in a portrait orientation in a poster generation tool according to a preferred embodiment;

FIG. 21 illustrates an example view of a workspace layout arranged to hide a task pane and content insertion tools in order to have a full-view of the poster under creation in a poster generation tool according to a preferred embodiment;

FIG. 22 illustrates an example view of the workspace layout arranged to showcase several versions of the same poster as formatted with different templates to facilitate easy user comparison thereof in a poster generation tool according to a preferred embodiment;

FIG. 23 illustrates an example view of controls provided to the user to change the dimensions and the number of columns of the poster in a poster generation tool according to a preferred embodiment;

FIG. 24 illustrates an example conceptual view of parameters used in a fine-tuning process by which manual and/or automatic optimization of content into the available poster area takes place in a poster generation tool according to a preferred embodiment;

FIG. 25A illustrates an example view classifying poster templates into thematic categories for enhanced user browsing and selection thereof in a poster generation tool according to a preferred embodiment;

FIG. 25B illustrates an example view of a template library in which the user may choose among a series of templates that are organized in thematic categories in a poster generation tool according to a preferred embodiment;

FIG. 26A illustrates a user interface of a poster generation tool including an optimal viewing distance indicator functionality and a media-specific poster adaptation functionality according to a preferred embodiment;

FIGS. 26B-26C illustrate optimal reading distance tables associated with the optimal viewing distance indicator of FIG. 26A;

FIG. 26D illustrates a color coding table associated with the optimal viewing distance indicator of FIG. 26A;

FIG. 27 illustrates an example view of a portion of poster content data adapted for fast and easy on-screen content review and correction by the user in a poster generation tool according to a preferred embodiment;

FIG. 28 illustrates an example view of options provided to the user upon saving the generated poster in a poster generation tool according to a preferred embodiment;

FIG. 29 illustrates an example view of poster content data as adapted into a journal paper-like printout for distribution, as provided by a poster generation tool according to a preferred embodiment; and

FIG. 30 illustrates an example view of an easy to use feedback report system available to the user in a poster generation tool according to a preferred embodiment.

### DETAILED DESCRIPTION

One or more of the preferred embodiments described hereinbelow relates to the computer-assisted generation of documents to be viewed by a community of human viewers in association with a hosted event according to document configuration guidelines established for the hosted event. One particular field of endeavor to which the one or more preferred embodiments are advantageously applied is the generation of scientific posters for viewing by an interested community of human viewers in association with a scientific conference. It is to be appreciated, however, that there is a wide variety of document types for viewing at a wide variety of hosted event types for which the one or more preferred embodiments are advantageously applied. Examples of the wide variety of document types includes posters of all kinds (scientific and non-scientific), magazines, newspapers, news announcements, advertisements, pamphlets, brochures, and books, either in printed or electronic form, and more generally any aggregation of information that can be viewably perceived by a human. Examples of the wide variety of hosted events includes, but is not limited to, conferences of all kinds (scientific and non-scientific) held on any of a variety of different schedules (e.g., on a one-time basis, a recurrent basis, an ad hoc basis) and in any kind of meeting format (e.g., geographically centered, geographically distributed) requiring any kind of human presence (e.g., physical or virtual). Further examples of the wide variety of hosted events includes, but is not limited to, one-time media publications, periodic media publications, and ongoing media publications, and so forth, provided only that there is some type of document configuration guideline expressed in some type of human-perceivable or computer-perceivable format that dictates one or more rules, suggestions, conventions, or standards for how the document is to be configured.

As used herein, a printed poster (or, more generally, a printed document) is one that is tangibly expressed in human-readable and generally permanent form on paper or other tangible substrate and created through the use of inks, paint, etchants, or the like. As used herein, an electronic poster (or, more generally, an electronic document) is a document in digital form that is rendered for human viewing on a computer monitor, such as a CRT display, LCD display, plasma display, an LCD or DLP projector, and so forth, and further encompasses documents in that may be viewable by rendering on future devices, such as optical aids, projection glasses, three-dimensional holographic systems, and so forth.

While certain functionalities according to one or more preferred embodiments may be presented hereinbelow in the particular context of certain hardware, software, or networking platforms or combinations, it is to be appreciated that the scope of the preferred embodiments is not limited to implementations on those hardware, software, or networking platforms or combinations, but rather extends to any of a variety of different hardware, software, or networking platforms or combinations capable of achieving like functionalities. Thus, for example, while certain examples of a document generation tool (such as a poster generation tool) according to a preferred embodiment may be described as a downloadable or disk-deliverable software package for loading and execution on a personal computer, such as a WINDOWS®, MACINTOSH®, or Linux-based personal computer, the scope of the preferred embodiments is not so limited and includes implementations of like functionality realized using any a variety of different hardware, software, or networking platforms or combinations, including, but not limited to: as a standalone special-purpose hardware appliance with fixed or upgradable firmware; as a USB drive or other hardware appliance attachable to a personal computer as an auxiliary device; as a kiosk-based service at airports, cafes, etc.; as a centrally hosted service accessible over the internet according to an application service provider (ASP); as a distributed hosting service accessible over the internet according to a cloud computing model, and so forth. Likewise, functionalities according to one or more preferred embodiments described hereinbelow as web-based or otherwise remotely-based services or databases may alternatively be implemented as downloadable or disk-deliverable software packages, USB drives, special-purpose hardware appliances, and so forth, without departing from the scope of the preferred embodiments.

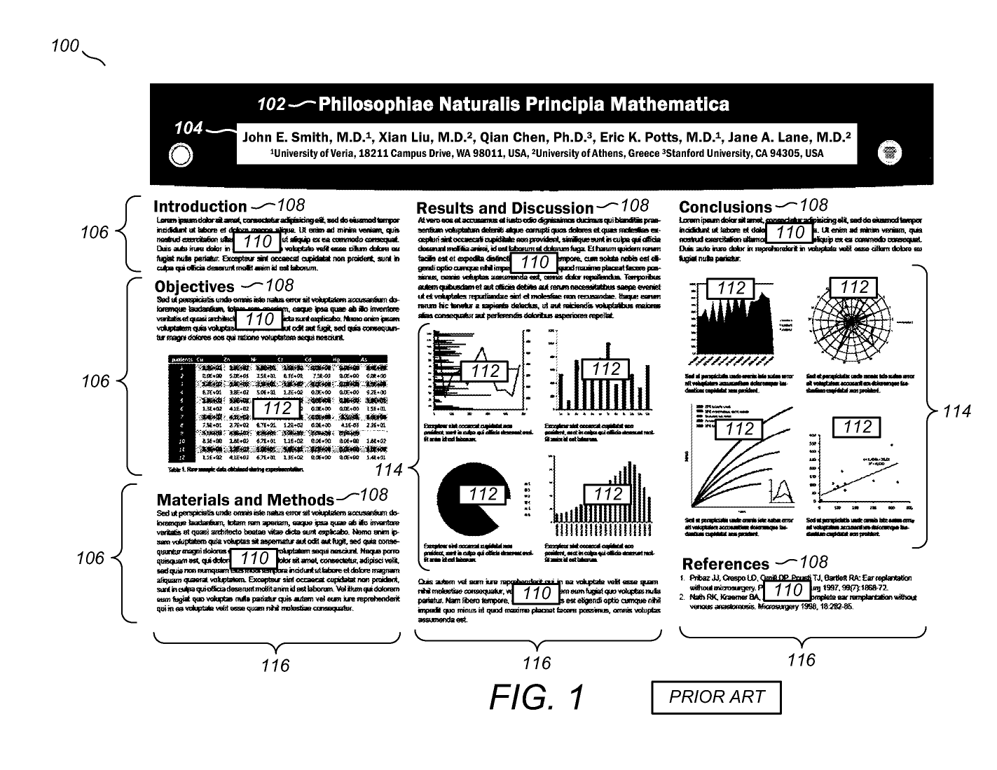

FIG. 1 illustrates an example of a scientific poster 100, the creation of which is particularly advantageous when using a poster generation tool according to a preferred embodiment. Poster 100 comprises a title area 102, an authors and affiliations area 104, and a plurality of content sections 106. Each content section 106 has a content section title 108. In the example of FIG. 1 the content section titles 108 are Introduction, Objectives, Materials and Methods, Results and Discussion, Conclusions, and References. Each content section 106 comprises at least one text segment 110 and/or at least one media gallery 114 comprising one or more media objects 112. Although the term “media gallery” is most often used to refer to groups of two or more media objects 112, the term “media gallery,” as used herein, can also refer to a single media object 112 by itself. Examples of media objects 112 can include, by way of non-limiting example, digital images, digital videos, digital audio information or visual pointers that activate audio processes, and interactive display windows.

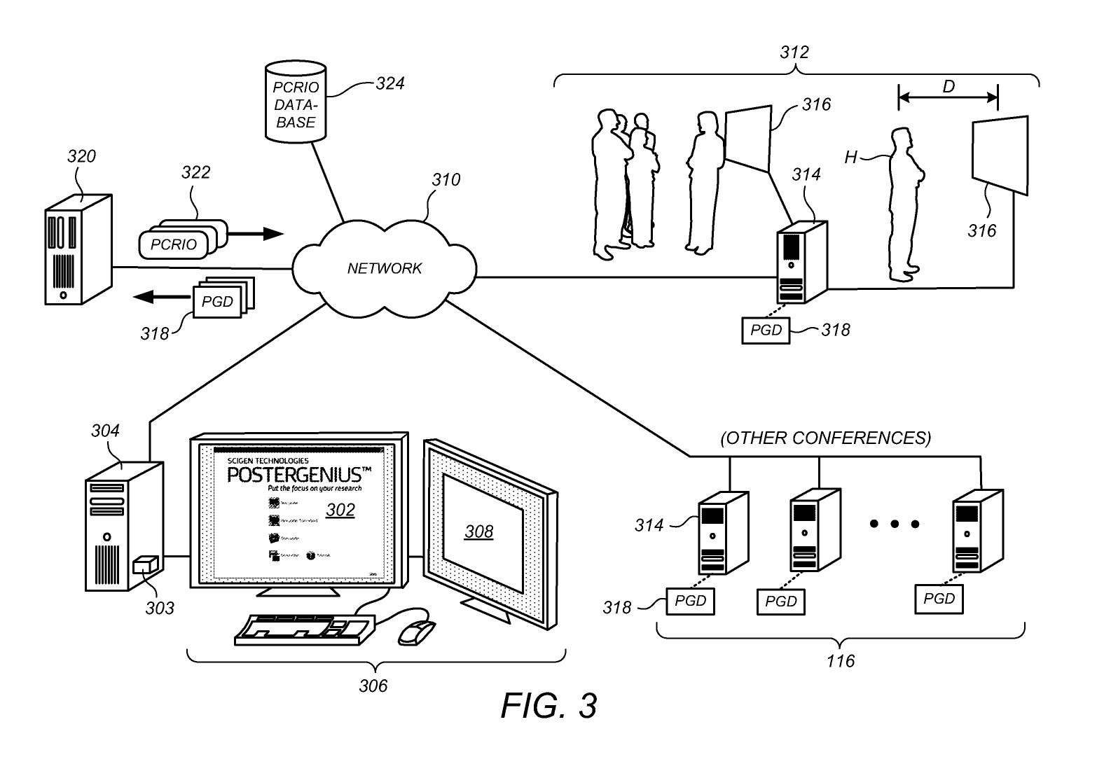

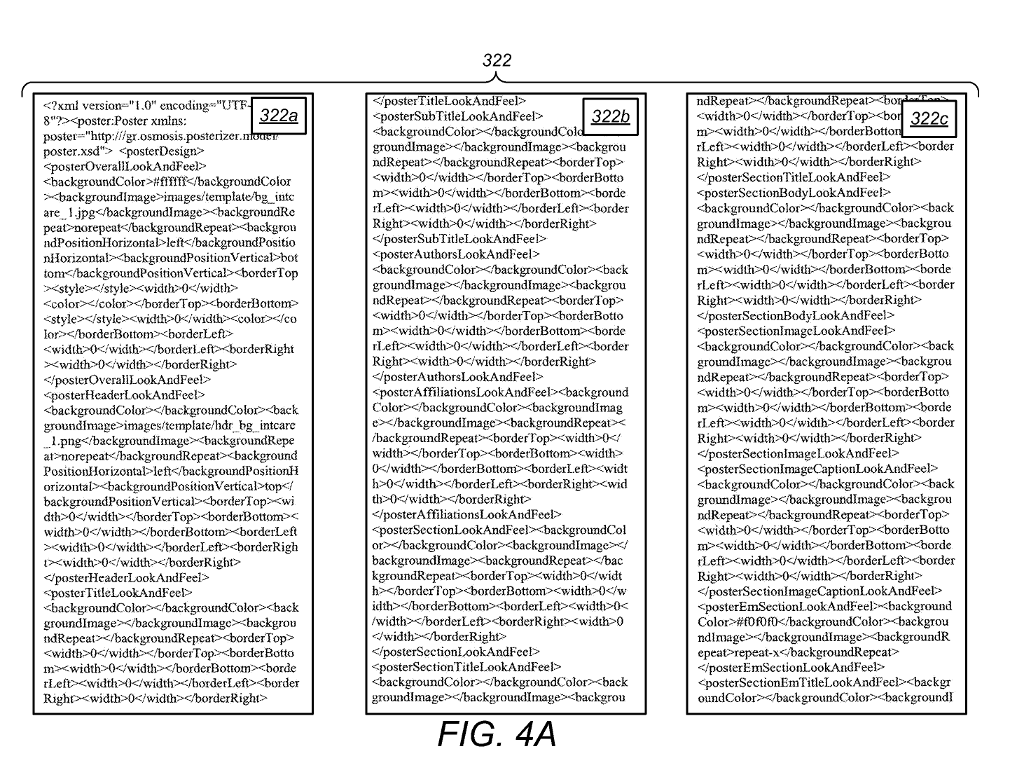

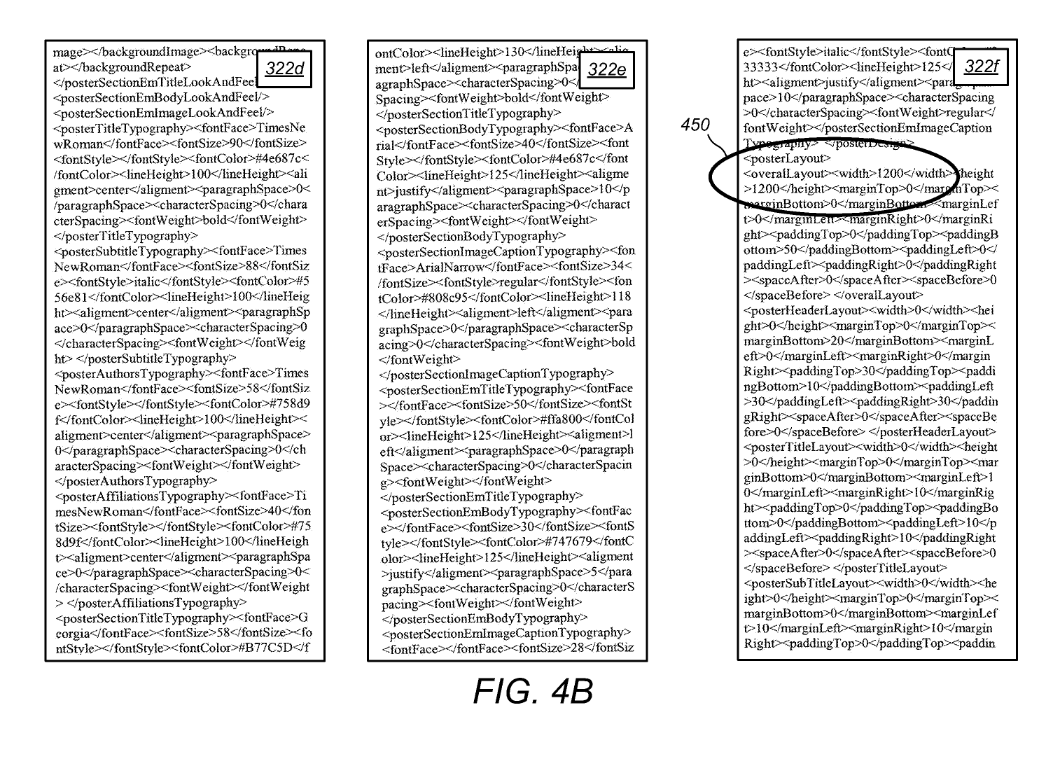

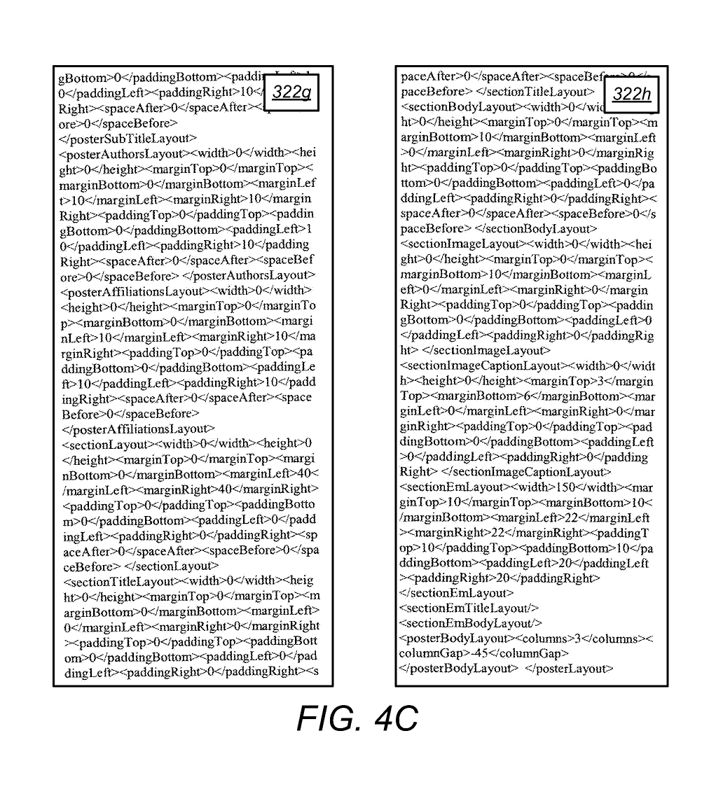

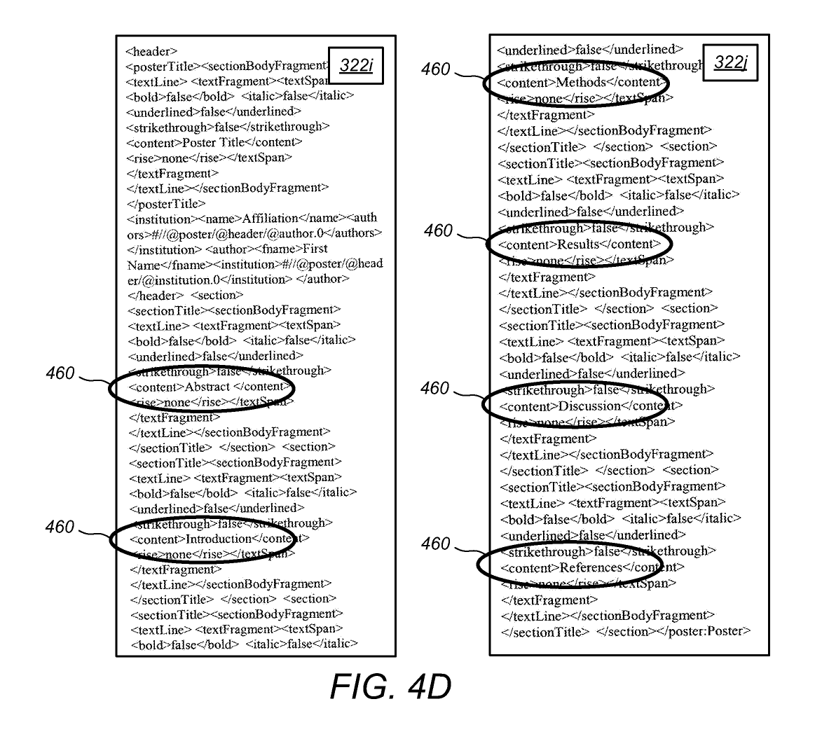

The poster 100 of FIG. 1 is organized into columns 116, the count of which in some preferred embodiments serves as one of the user-selected and/or user-adjusted cornerstone parameters around which the document layout is automatically organized. Thus, for example, during a poster set-up process to be described further below, the user identifies how many columns are desired, and then the automated poster generation tool structures the poster around that number of columns (as well as, of course, the relevant poster configuration guidelines as expressed in a poster configuration rules information object, as will be discussed further below). However, in other preferred embodiments, there can be other types of bounded regions, other than columns 116, around which the poster is structured. For example, in other preferred embodiments, there may be user-defined bounded regions that are input by the user at the beginning of the process (e.g., using a mouse click-and-drag technique), and then those bounded regions serve as a basis for the distribution of content rather than the columns 116. As another example, there may be bounded regions as specified by a predetermined poster configuration guideline as stored in a poster configuration rules information object (see PCRIO 322 of FIGS. 3-4D, infra). It can be specified in the PCRIO, for example, that each respective bounded region is to correspond to a respective predefined content section of the poster. Accordingly, it is to be appreciated that the scope of the preferred embodiments is not limited to column-centric approaches to content spatial layout.

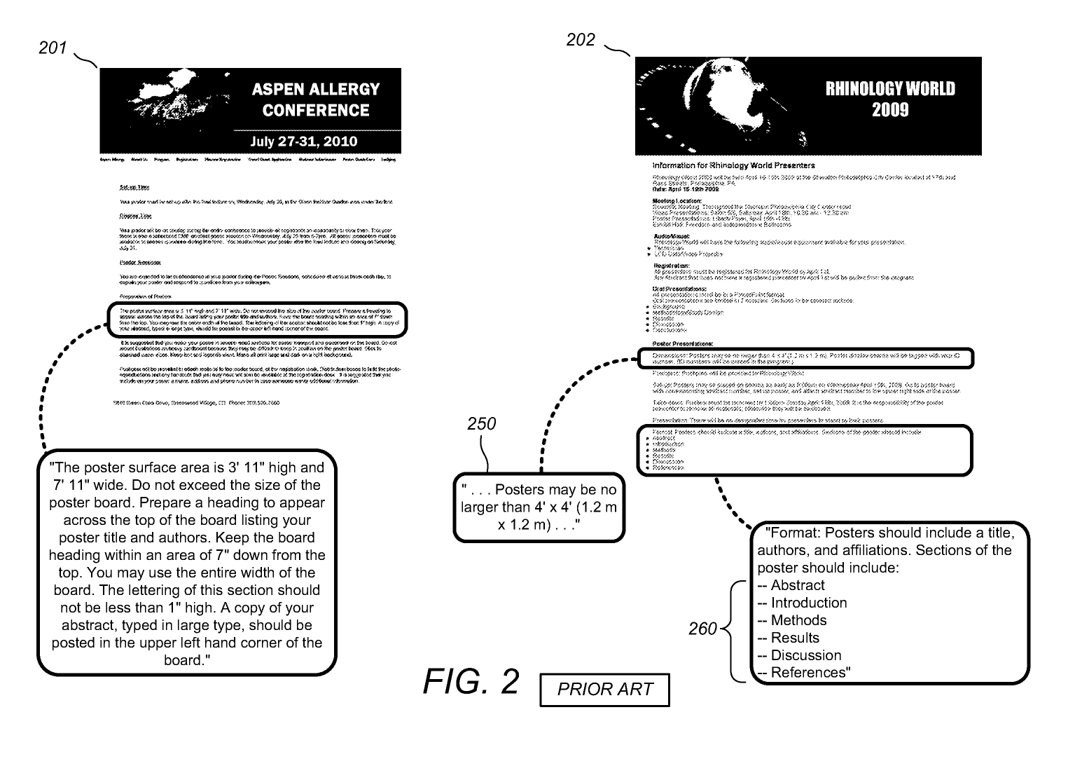

FIG. 2 illustrates examples of prepared guidelines documents 201 and 202 for the generation of scientific posters. As illustrated in FIG. 2, the prepared guidelines documents offered by scientific conferences are generally not conformant to each other in terms of their layout, and they usually provide the poster configuration guidelines themselves as part of a larger document that varies widely in tone, content, and specificity of instruction. While historically provided mainly in mailed paper form, the prepared guidelines documents are increasingly provided in electronic form on web sites or web pages created for the scientific conference.

As mentioned above in the background section, the conventional prior art way of complying with the guidelines first requires, in addition to locating the correct paper document or web site, that the poster author wade through the prepared guidelines documents for the particular poster configuration that they are looking for. Highlighted in FIG. 2 for the attention of the reader of the present disclosure, which will be referenced again infra, are two exemplary segments of information 250 and 260, respectively, that dictate one or more poster configuration rules. The segment 250 dictates the maximum size of the allowed posters as 1.2×1.2 m, while the segment 260 dictates content section constraints for the poster. Specifically, in addition to specifying that there needs to be a title and authors and affiliations, there is required to be six (6) content sections having the content section titles Abstract, Introduction, Methods, Results, Discussion, and References.

FIG. 3 illustrates a scientific poster generation, distribution, management, and display environment including a poster generation tool 302, a poster configuration rules processing server 320, and a plurality of conference hosting servers 314 executing methods according to one or more of the preferred embodiments. It is to be appreciated that FIG. 3 is a simplified conceptual illustration presented so as to clearly describe the preferred embodiments herein. A variety of computing, storage, and networking hardware associated with various components of the network, such as databases, application servers, internet gateways, e-mail servers, internal and external routers, security devices, internet service provider facilities, and related software protocols and methods necessary for operation are known in the art and need not be detailed here. In view of the present disclosure, a person skilled in the art would be able to construct software packages and/or suitably configured hardware and networking products capable of achieving the functionalities described herein without undue experimentation, using publicly available programming tools and software development platforms.

Illustrated in FIG. 3 is a poster generation tool 302 according to a preferred embodiment that, for simplicity and clarity of presentation, is identified in the drawings as the user interface screen thereof at any particular point in time during use. As would be readily understood by a person skilled in the art, the poster generation tool 302 can itself be expressed or embodied in a variety of physical formats. Thus, for example, equivalent descriptions could alternatively set forth the poster generation tool 302 as a piece of storage or processing hardware 303 inside a computer 304 of the poster author (hereinafter “user”), containing computer code that causes a processor to execute the methods described herein.

In one preferred embodiment, the poster generation tool 302 is similar to a commercially sold software product named POSTERGENIUS™, having a Version 1.0 that was released in May 2009 by SciGen Technologies, S.A., of Xanthi, Greece, the assignee of the instant application, as a WINDOWS® compatible downloadable or disk-deliverable software application. Associated with the user's computer 304 is a computerized user interface 306 including input devices (keyboard, mouse, etc.) and display devices (one or more monitors, speakers, etc.). Although the poster generation tool 302 is certainly adaptable for use as a first-generation content input tool, in which the user manually types in the words of the content segments and draws the charts, the poster generation tool 302 is particularly suited and adapted for the generation of a poster based on an antecedent document, such as may exist in MICROSOFT® WORD® or COREL® WORDPERFECT® format, which was already created by or on behalf of the user, or that is otherwise available to the user. Accordingly, shown in FIG. 3 is an antecedent document 308 illustrated as a window on the computerized user interface 306.

Among other features, poster generation tool 302 is optimized for the easy cutting and pasting of content data thereinto from the antecedent document 308. As the term antecedent document is used herein, the antecedent document 308 can actually comprise a collection of electronic documents in a variety of different formats, as is the case, for example, when the user might cut most of their content data from their recent journal article in WORD® format, but then might use a web browser to search the web for suitable photographs or the like to cut and paste into their documents. Accordingly, as the term antecedent document is used herein, the antecedent document 308 encompasses a rich variety of electronic data sources from which the user may “cut” or “copy” content data for use in their poster.

Also illustrated in FIG. 3 is a network 310, such as the Internet, for enabling data delivery and communications between the user computer 304 and the other nodes shown, including a plurality of hosting servers 314, a poster configuration rules processing server 320 (hereinafter “PCR server 320”), and a poster configuration rules information object database 324 (hereinafter “PCRIO database 320”). Also illustrated in FIG. 3 is a typical scientific conference 312 in which a population of posters 316 are displayed to a population of human viewers H. For purposes of description, one can consider an example in which the scientific conference 312 is “Rhinology World 2009” for which the prepared guidelines document guideline 202 in FIG. 2, supra, was created.

In the particular example of FIG. 3, the posters 316 are electronic posters, for which case there is a particularly advantageous preferred embodiment described further infra that can make the user's experience at the conference much easier, more enjoyable, and less prone to mishap. More generally, however, the posters 316 can be considered as being in either printed or electronic form.

Each of the different hosting servers 314 is generally administered by a different entity who is hosting a different scientific conference. Thus, for example, the “Rhinology World 2009” conference 312 administers the uppermost hosting server 314 drawn in FIG. 3, while other, unrelated scientific conferences 116 administer different ones of the lower hosting servers 314 of FIG. 3. Also illustrated in FIG. 3 is a separation “D,” termed herein the poster viewing distance, which is the spacing between any particular viewer and the poster being viewed. Also shown in FIG. 3 are PGD documents 318, where PGD stands for prepared guidelines document, examples of which were presented supra in FIG. 2, each scientific conference usually making its own PGD document 318 which has little in common with other PGD documents in terms of structure, layout, tone, detail, and the like.

According to one preferred embodiment, the PCR server 320 is configured, programmed, and adapted to seek out the PGD documents 318 using any of a variety of different methods (e.g., web crawling, compiled and updated lists of URLs, scanning/OCR of PGD documents, etc.), and to automatically analyze the contents of these documents (e.g., using keyword searching or more complex analysis programs such as those based on neural networks) to extract therefrom a common, standard, and/or universal data object that expresses how the poster is to be configured in a are, in a common, standard, and/or universal format, that data object being termed herein a poster configuration rules information object (PCRIO), examples of which are enumerated as elements numbered 322 in FIG. 3. Preferably, a relatively large number of PCRIOs 322 are computed by the PCR server 320 and stored in the PCRIO database 324. In one preferred embodiment, the PCR server 320 is programmed and administered by the provider of the poster generation tool 302.

According to one preferred embodiment, once the PCRIO database 324 is formed, the poster generation tool 302 communicates with the PCRIO database 324, receives a listing of all of the different scientific conferences for which PGD's were processed into PCRIOs, and displays that list to the user. If the conference for which a poster is to be generated is listed, the user can then select that conference, at which point the relevant PCRIO is delivered from the PCRIO database 324 to the user computer 304 for use by the poster generation tool 302, which uses it as a basis for creating the desired poster. According to another preferred embodiment, the contents of the PCRIO database 324 can instead be provided, in whole or in part, as part of the poster generation tool 302 itself, wherein the computer 304 can serve as its own PCRIO database. Optionally, the user can access the web site of the provider of the poster generation tool 302 and receive updates to the PCRIO database. As another option of the provider of the poster generation tool 302 can push PCRIO updates to the user's computer 304, similar to the way that antivirus programs are updated and operating system patches are delivered.

FIGS. 4A-4D illustrate an example of a PCRIO 322, as translated into human readable format for purposes of this description and printout out into columns 322a-322j. For this particular example, the PCRIO 322 corresponds to an output of the PCR server 320 when the “Rhinology World 2009” prepared document guideline 202 of FIG. 2, supra, is processed. Thus, for example, FIG. 4B illustrates a portion 450 of the PCRIO 322 that corresponds to the data segment 250 of FIG. 2, specifying a height and width of 1200×1200 (the default unit is millimeters) corresponding to the statement, “Posters maybe no larger than . . . 1.2 m×1.2 m” in the data segment 250. As another example, FIG. 4D illustrates portions 460 of the PCRIO 322 that correspond to the data segment 260 of FIG. 2, which specify that the poster must contain the content sections of Abstract, Introduction, Methods, Results, Discussion, and References. The PCRIO 322 is advantageously expressed in a common, standard, and/or universal format that can be properly interpreted by poster generation tool 302, regardless of the particularities of the prepared document guideline of the intended conference upon which it is based, thereby saving the user substantial time, effort, and frustration.

According to a preferred embodiment, based on the PCRIO 322 associated with the selected conference, the poster generation tool 302 then provides the user with an easy-to-use, intuitive interface described further hereinbelow that constrains the manner in which content data is pasted, such that the user is “forced to obey” the conference guidelines regarding the content section constraints, including how the sections are named and sequenced, regarding the kinds of content (e.g., what kind of media objects) that are allowed and in what sections those contents can be placed, and so forth. The overall process of poster creation is thereby streamlined and improved.

Poster generation tool 302 is designed to enable easy and fast creation, as well as shipment and delivery of professional looking documents, such as scientific posters. Poster generation tool 302 separates the content from the design of a document, hereafter a poster. Therefore, poster generation tool 302 frees the poster author from investing time and effort to the aesthetics of his poster, as it ensures that the content will be presented in a professional looking way. Consequently, the poster generation tool 302 allows the poster author to focus on his primary aim, which is to describe and discuss the content. The poster author utilizes one part of the poster generation tool 302, namely self-explanatory data-entry forms, to easily insert all content, be it images, graphs, text or multimedia in substantially lesser amount of time, compared to the existing state-of-the-art. The final design and layout of the poster is carried out entirely by the poster generation tool 302, based upon the user's choice among a premade list of professionally designed templates. An important component of poster generation tool 302 is the optimization of poster content on the poster dimensions and design, an option offered by the described system that is available to the user, for the best aesthetical result. The poster generation tool 302 makes it feasible for the non-expert user to complete the creation of his poster in a significantly lesser amount of time, compared to the current state-of-the-art, typically within 5 to 15 minutes.

Unless indicated otherwise, the terms software application, disclosed software, and disclosed application hereinbelow each refer to the poster generation tool 302. By double clicking on an executable file the user installs the software application on their computer which supports a Graphical User Interface through a few easy steps. If a previous version of the software exists on the computer, the software installer prompts the user upon keeping or deleting existing files (older posters, user settings etc.). The user may wish to keep them, therefore making an upgrade from an older to the newer version, or remove them from their hard drive, therefore making a clean installation.

Regarding the disclosed software application workflow, with the disclosed system, there are two scenarios for the creation of a poster. The first is that the poster author types the text content directly into the software application system of the disclosed method and following that, inserts the rest of the content, be it images, graphs or multimedia. This workflow is further disclosed later on. The second and most usual scenario is that the poster author has already submitted an abstract or paper to a conference or a journal scientific committee, for scientific reviewing. Therefore, the poster author already has the content, be it text, images, graphs or multimedia, gathered usually in an antecedent document, and the user needs to insert them to the disclosed system. The disclosed system makes both scenarios easy for the poster author to accomplish.

For the creation of a poster, the poster author (hereinafter “user”) starts the disclosed application. A splash screen appears which shows the current version of the software. After the splash screen is shown, a welcome screen appears providing access to several actions that aid the user in accomplishing creation of the poster easily. By way of example, such actions are “new default poster”, “new poster from wizard”. Furthermore, options to open existing posters by a designated action (“open existing poster”), as well as to train oneself in using the system (“view tutorials”). An option to deactivate the welcome screen from being shown at startup is also provided. By choosing this option and upon re-launch of the program by the user, the welcome screen does not show up anymore, unless the user wishes to bring it back through a designated preferences dialogue. Furthermore, a control to simply close the welcome screen is provided, by which the user simply closes the welcome screen, without deactivating its appearance upon the next launch of the program by the user.

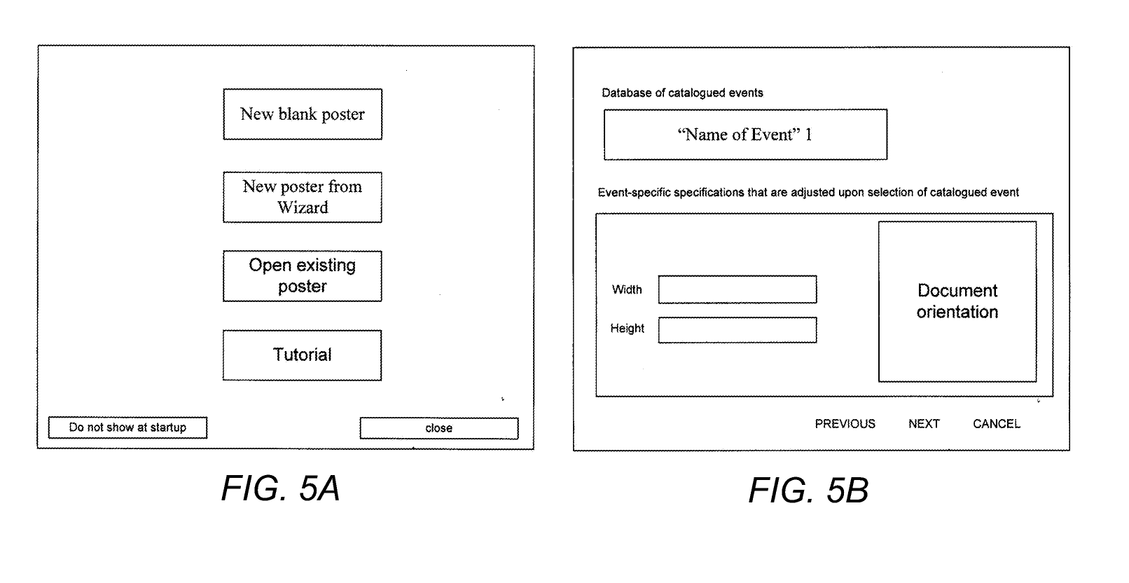

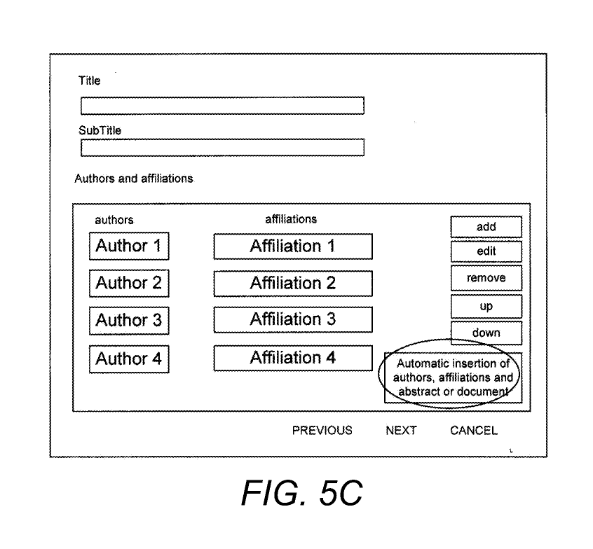

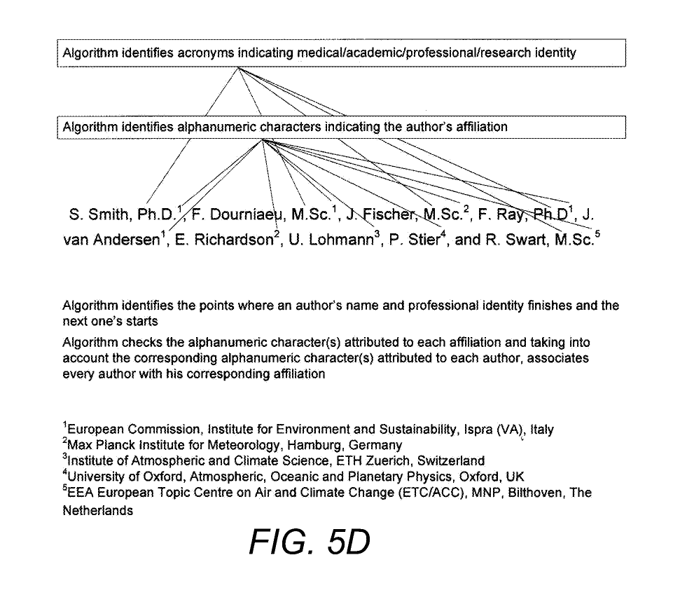

FIG. 5A is an example view of the welcome screen of the disclosed software application. Actions are provided for easy poster creation, fast access to existing posters as well as training material. By choosing the option for “new default poster” the user creates a new poster which has a default structure of sections with pre-input section titles as an aid. Following, the user enters the main Graphical User Interface (hereafter, GUI) of the application. From there on, the user can input their content, be it text, images, graphs or multimedia and finish the creation of their poster according to the workflow disclosed below. By choosing the option “new poster from wizard” the user creates a poster by use of a simple, few-step wizard.

For the creation of a new poster from the wizard, to start the wizard, the user defines the dimensions of their poster. A regularly updated list of supported scientific/academic events (by way of example, scientific conferences) is provided. The user may choose the conference or event of their interest and the disclosed system adjusts all poster properties according to the pertinent guidelines of the chosen event.

The database of supported events (e.g., PCRIO database 324) eliminates need to read through the document preparation guidelines and ensure compliance with them. A unique important feature of the presented system is the collection, processing, cataloguing, archiving and digital representation of all information related to a set of specifications, restrictions or recommendations for a poster in a digital record. Such records are furthermore grouped into a database system that makes such information available to the rest of the proposed system automatically available, without user intervention. The database of events also offers notification to the user regarding specific deadlines, travel arrangements and all information needed for the user to attend a specific event.

Therefore, the user does not need to read through the document preparation guidelines of the specific event (e.g. poster preparation guidelines for a scientific conference) and ensure compliance with them, as the presented system takes care of this. A multitude of major events in a variety of fields is fully supported by the disclosed method in this aspect. Furthermore, for supported events, the disclosed system connects with a database and informs the user of certain events like the date, time and place where the poster has to be mounted. Lastly, if the event that the user wishes to attend is not included yet or the list of specifications requested is not among the predefined options, the user may easily add a new set of specifications and save them for future reuse.

FIG. 5B is an example view of the process upon which the user defines the dimensions of their poster, in the disclosed software application. Clicking on the “Database of catalogued events” brings up a list of the hosted events for which PCRIOs 322 have been created, such as a drop-down list from which the user can select their conference. Following this step, the user is prompted to input the title and subtitle of the poster. The user may type or copy all required fields using data available from another system, e.g.: from a word processor where the user has prepared the abstract. Following, the user is prompted to enter the list of poster authors and each author's affiliation data. The user may type the above data in the forms provided by the disclosed system.

Advantageously provided according to a preferred embodiment is automatic identification of authors, affiliations, and the association therebetween based on generally disparate listings thereof in an antecedent document, and automated insertion of the identified authors and affiliations in the poster. The antecedent electronic document includes (a) a first data block listing a plurality of author names, (b) a second data block listing a plurality of affiliations, (c) a plurality of intermediate characters not part of author names or affiliation names distributed among the first and second data blocks from which can be identified associations among the authors and the affiliations. To implement this, the user simply copies the blocks containing the authors' names and their affiliation information as blocks of text from the different places in the original application where they appear, and pastes them into the pertinent form of the software application system of the disclosed method. The software application will then automatically recognize the different authors and affiliations and separate them from each other, while matching each author with the corresponding affiliation. The user may also designate authors to be emphasized, e.g. corresponding authors etc. Following this, the user may insert the written abstract or a document directly from another application where it was originally created, as is further disclosed below. Lastly, the poster author need not finalize these data immediately, as they can always be accessed and edited later on.

FIG. 5C is an example view of the following step of the wizard, in the disclosed software application. The ellipse designates the special tool designed for easy, automated insertion of authors, affiliations and abstract or document by a simple copy-paste from the original application where they were typed.

Advantageously, the disclosed system has been created that can read through a sequence of alphanumeric characters containing the names of authors and affiliations and identify the different authors and affiliations, and separate them from each other while matching each author with their corresponding affiliation. The method consists of searching inside the author(s)' block of text and identifying: acronyms related to their professional identity; alphanumeric characters that are not part of their name or acronym declaring professional identity, and declare their relationship with one or more affiliations; the beginning and end of every author in the block of text, thus identifying the number of authors, and the name and surname of every author. Following, the method consists of searching inside the affiliation(s)' block of text and identifying alphanumeric characters that are not part of the affiliation's name, designating their relationship with one or more authors, and the beginning and end of every affiliation in the block of text, thus identifying the number of affiliations, and the text corresponding to every affiliation. Following, the method attributes each author, including their name, surname and professional identity, with their affiliation, based on the alphanumeric characters identified as mentioned above. FIG. 5D is a view of the concept by which the method for the automatic insertion of authors and affiliations works.

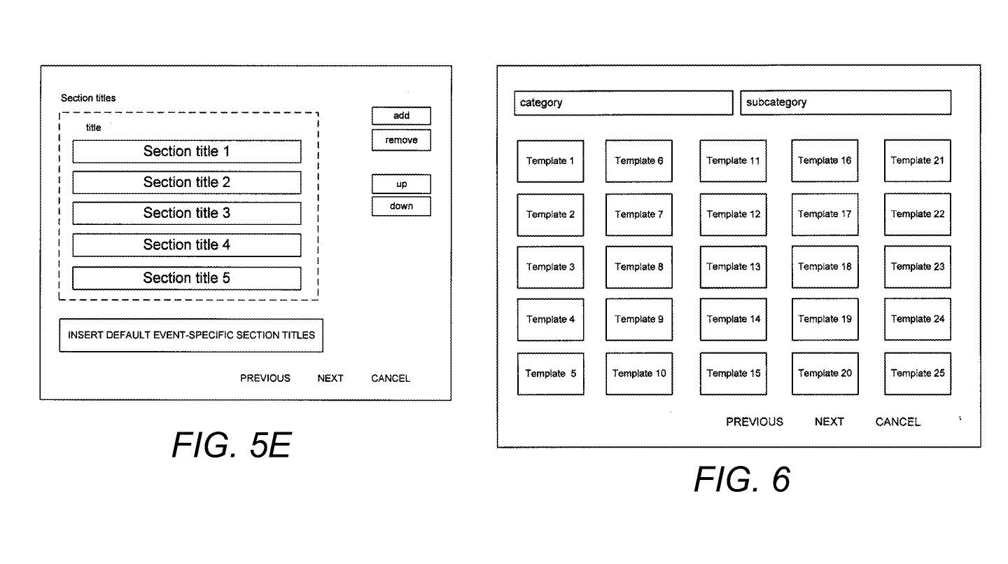

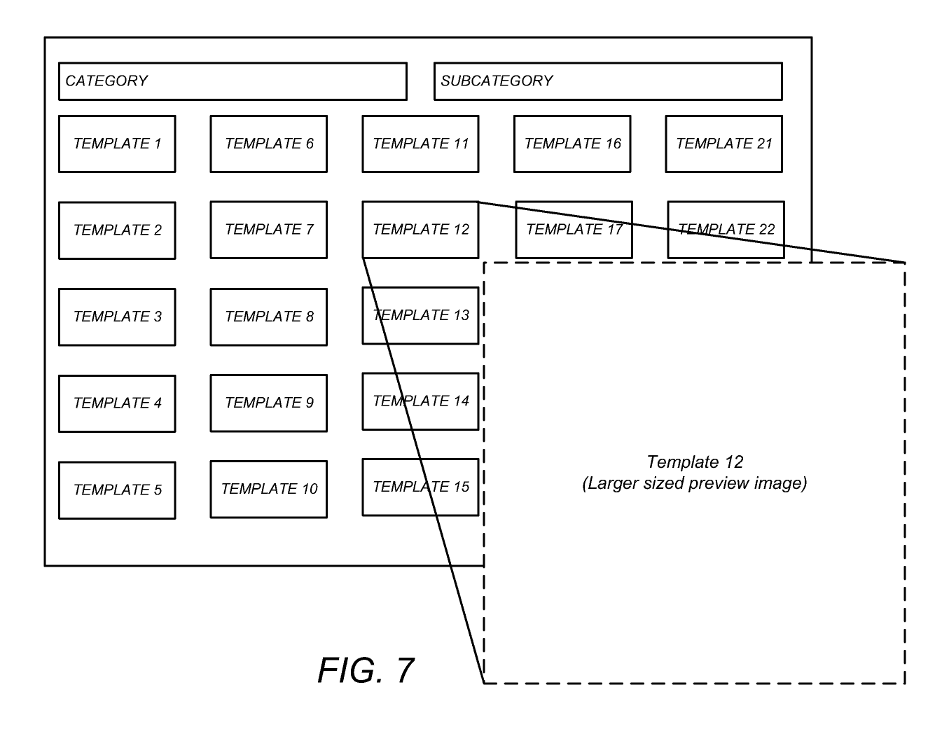

Next, the user is prompted to define the poster's section structure. A list of section titles is provided for assistance as determined according to the event the user chose previously. In case the user did not choose any event previously, a list of default section titles is offered for convenience. FIG. 5E is an example view of the next step of the wizard, of the disclosed software application, by which the user may defined the poster's section structure. Following, the user is prompted to choose the design and layout of the poster, among of a library of professionally designed templates. Templates are further disclosed below. These templates can always be accessed and applied later on, as well. FIG. 6 is an example view of the next step of the wizard, of the disclosed software application, by which the user may choose the design and layout of the poster, among of a library of templates. FIG. 7 is an example view of the larger preview image demonstrating a poster with sample content formatted with a specific template that the user has selected from the template library.

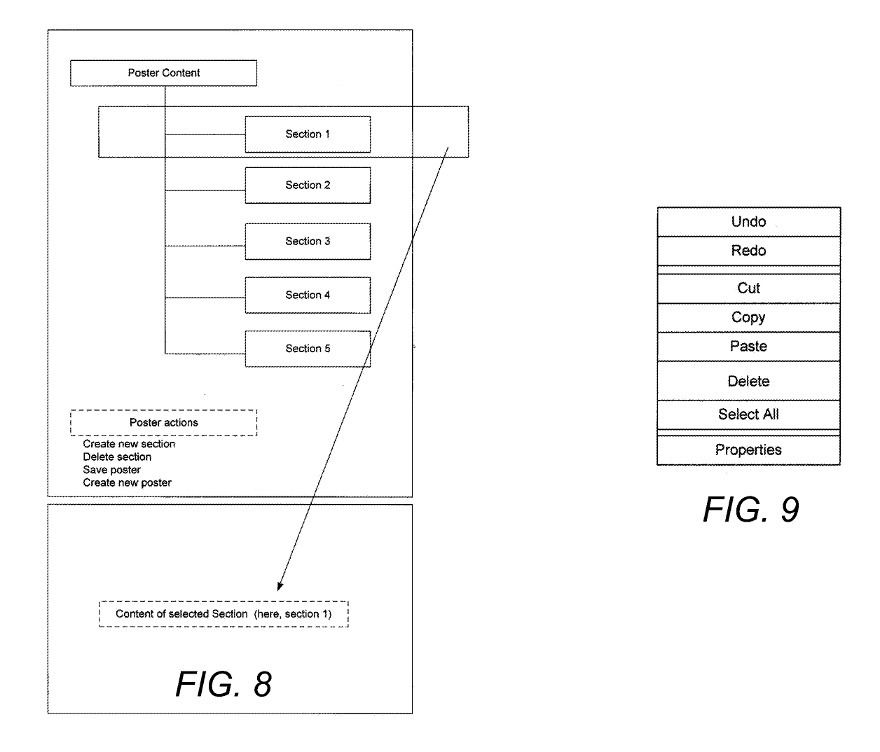

FIG. 8 illustrates a portion of a user interface screen of the poster generation tool 302 that provides, among other features, a constrained content input environment according to a preferred embodiment. A task pane is provided for the user, from which the user can access the contents of the poster, the library of templates as well as the poster the user has recently created. The user interface screen of FIG. 8 advantageously aids the user in easily navigating through the sections and viewing and inserting content in every section. The user may click on “my poster” to bring the rest of the content into the poster. To do so, the user chooses one of the sections of the poster in the structure tree and then copies content, be it text, images, graphs or multimedia data from other applications, and pastes them into the corresponding section of the poster. To do so, the user can use context-sensitive menus (accessed through right click), regular menus or toolbars. The pasted text maintains structure and standard formatting used in publications, be it bold, italics, underline, sub and superscripts, bullet formatting, text color etc. Alternatively, the user may simply type their text into the designated rich text editor fields and format it accordingly, using all standard formatting applicable in publishing like bold, italics, underline, sub and superscripts, bullet formatting, text color etc. FIG. 9 is an example view of the various options by which the user may copy-paste content from or into the poster.

The use of the user interface screen portion of FIG. 8 as a constrained content input tool are now further described. Included among other items in the task pane and toolbar section of FIG. 8 (i.e., the upper large rectangular area of FIG. 8) is an important content section selection feature taking the form of multiple buttons (or similar selectable, sequenced menu items) labeled Section 1, Section 2, Section 3, Section 4, and Section 5. Further buttons not shown in FIG. 8, such as Section 6, Section 7, etc. (if needed) are provided by scrolling. Thus, for the above “Rhinology World 2009” example, the content section selection feature of FIG. 8 would be showing the term “Abstract” at the Section 1 button, “Introduction” at the Section 2 button, “Methods” at the Section 3 button, “Results” at the Section 4 button, and “Discussion” at the Section 5 button, and there would also be a scrollably viewable Section 6 button labeled “References” underneath the Section 5 button. This corresponds directly to the prepared document guidelines of the Rhinology World 2009 scientific conference, as embodied in the corresponding poster configuration rules information object (PCRIO 322), which specify those particular six sections in that particular sequence.

Importantly, according to one preferred embodiment, unlike with a conventional document preparation package in which the user is generally provided viewable WYSIWYG (what you see is what you get) access and editing of the whole document, the poster generation tool 302 provides a constrained environment that forces the user to comply with the prepared document guidelines of the scientific conference, as embodied in the corresponding poster configuration rules information object (PCRIO 322), in terms of the content section constraints and sequence. More particularly, in order to even be permitted to get their content data pasted into the poster, the user must select one of the six section buttons (for example, the “Methods” button), at which point the bottom frame of FIG. 8 (content input frame) will then accept user-pasted content only for that section, and will sequester that content into that section (for example, the “Methods” section), keeping that pasted content segregated from content data in other sections of the document.

Moreover, in other preferred embodiments, the PCRIO 322 further constrains the type of content data that is permitted into any particular content section. For example, when the “Abstract” button is chosen, the user can be prevented from pasting any kind of media object into the content input frame. This might be the case, when there is a persnickety conference organizer who specifies that “Abstracts” are never supposed to contain anything but text. The conference organizer would write that admonition into their prepared guidelines document, and that admonition is transformed by the PCR server 320, supra, into the associated PCROI 322 which is, in turn, enforced by the poster generation tool 302.

Generally speaking, absent any of the conference organizer prohibitions discussed in the preceding paragraph, the content input frame of FIG. 8 will accept both user-pasted and user-identified content data. As used herein, user-identified content data generally refers to any content data that is not pasted from the clipboard but that is otherwise identified to be included into that section, such as user-typed text, user-spoken text (as might be acquired with a voice recognition application), and user-entered text modification controls (such as italics, bold, underline). User-identified content data can also include content data that might not even exist yet at the time of user input, such as links to web sites having known kinds of information, or other data objects that can be “compiled” at the time of rendering. By way of example, instead of pasting in a particular JPG image of a weather satellite photo, the user might include a link to an external web site that maintains weather satellite images, and it will not be until actual rendering time that an actual, most-recent version of the weather satellite image is fetched and included into the poster at that content section.

The import of content from other applications is now discussed. The disclosed software application provides a method for data exchange with other systems that perform text, image, graph and plot manipulation and other data processing functions. This is an option offered by our system that in no way restricts the application of our invention to systems that have these other data processing systems present. Part of our invention is the ability to export data from the proposed system to other data processing systems, such as word processors, spreadsheets, slide presentation or design software.

The user may at all times activate or deactivate spell checking in the language the user is currently writing. The spellchecker informs the user of identified misspellings and suggests alternative spellings from its built-in vocabulary, while offering the capability to add unregistered terms in its database. The user may at any time insert additional sections by using the pertinent menu. Moreover, the user may add new author(s) to the list of poster authors. Additionally, the user may at any time delete or rename existing sections by choosing the pertinent section title from the content structure tree in the task pane.

The insertion and arrangement of media objects such as images, graphs, and multimedia into groups is now discussed. A multitude of options is provided for insertion of objects such as images, graphs and multimedia. The user may click at the point in the text where the user wants the image(s) inserted and add an object be it a photo, a graph, or multimedia file from a collection of existing objects. Alternatively, the user may copy the object(s) from the application where it is created/inserted or currently resides e.g. a word processor or other slide presentation software, and paste it in the disclosed software application, at any point into the text. This can be done for a single object or for a number of objects. All objects inserted by the user with one of the aforementioned ways are arranged into object groups. Upon the user's request these groups of objects may be easily formatted in a variety of layouts. Additionally, these objects and groups of objects are automatically resized to an appropriate size so that a visually aesthetic and legible result is created, which saves the user from having to manually carry this out. The aforementioned size of objects and groups of objects is automatically calculated based upon poster dimensions, number of columns, as well as typographic and other parameters. The calculation is independent from the content of objects or groups of objects. However, all objects and groups of objects may be manually resized by the user as well.

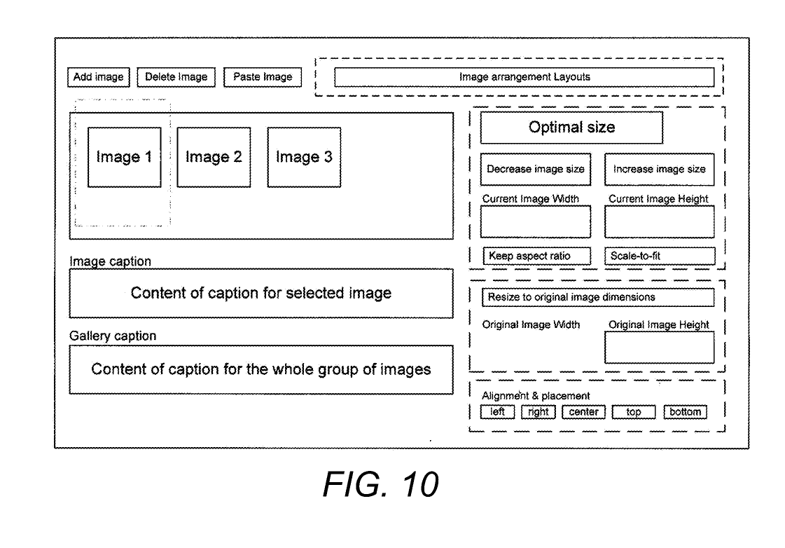

A multitude of object group layouts is offered for automatic arrangement of objects. The user may easily rearrange the objects into one or more layouts, in a simple manner, by way of example with a simple click. Additionally, the user may at any time adjust the alignment of each object independently from the others, in a simple manner, by way of example with a simple click. The user may easily insert a legend for each and every inserted object. Additionally, the user may add a global legend for every gallery of objects inserted. FIG. 10 is an example view of the multiple options provided for the user to arrange and resize multiple objects, as well as insert captions individually for each one of the them as well as global captions for groups of objects. By way of example, this conceptual sketch refers to arrangement of images.

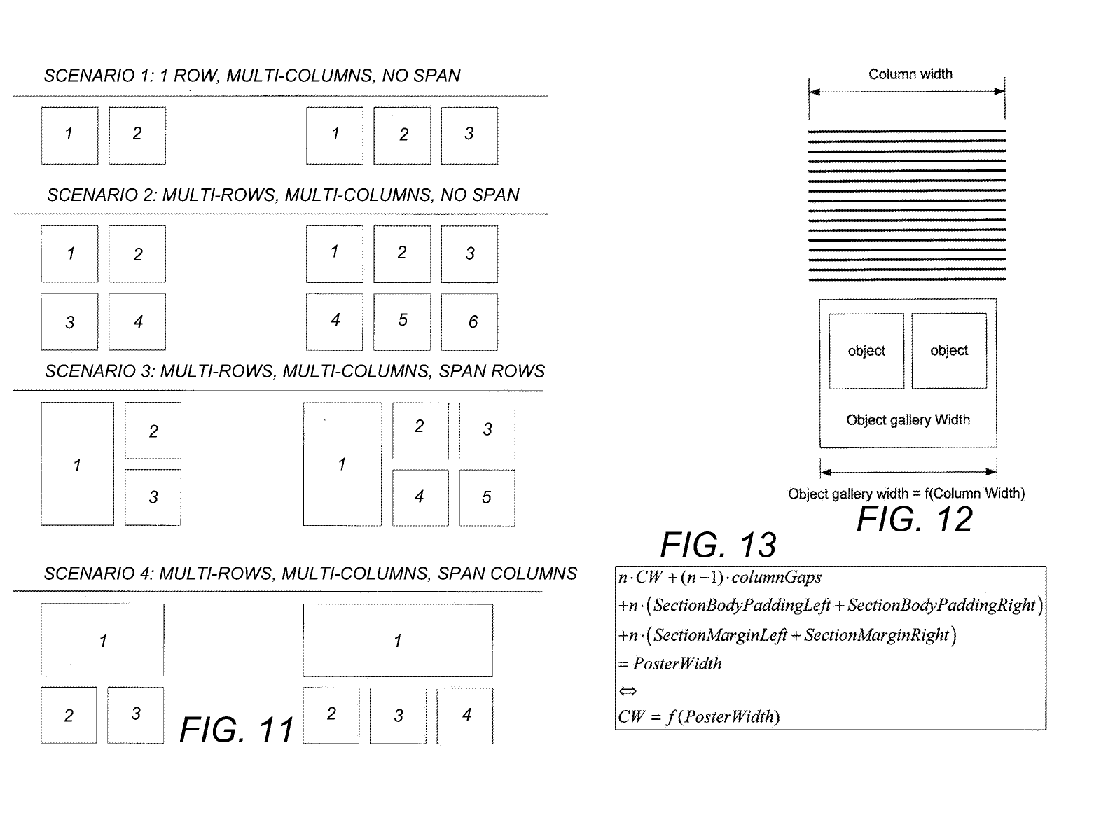

Arrangement and resizing of objects is now discussed. Objects organized into groups may be arranged into a multitude of layouts for best conveyance of the user's information and message or best aesthetical result. The object group layouts presented below are some of the examples that can be used by our system. These layouts can be further combined to produce more layouts and can also be adjusted to fit each user's needs. FIG. 11 is an example view of some of the layouts groups of objects may be arranged into.

A typical issue at hand, when designing and laying out a document containing text and objects, such as images or graphs, is adjusting the size of these objects to obtain the best overall result. More specifically, when content is arranged in columns of text and objects, it is usual to attempt identifying the best size for these objects, so that the final overall result is both aesthetic and legible. While the definition of “aesthetic result” entails subjectivity, a method is created to facilitate its easy identification while assuring legibility. Introduced is a parameter that refers to the “optimal” size of an object or group of objects, which are laid out in a poster containing one or more columns of text. The term “optimal” is used as a shortcut for the sake of clarification on what is desired, and is by no means restrictive. Referred to as an “optimal size” is a size of an object which is inserted in a poster containing one or more columns of text, as a parameter dependent on a number of other parameters like, by way of example, the width of the column and the dimensions of the poster. The dimensions of the poster and the number of columns have normally been already adjusted by the user at a previous stage. Usually, upon laying out a document containing text and objects, resizing of every individual object is required. This resizing usually has to be manually made. The disclosed method aims at providing automations to the user, so that the user may create their own object resizing rules that can be applied to all inserted objects. To achieve this, we introduce another parameter, dubbed “factor” which is incorporated into the automatic calculations of the disclosed method for adjusting the “optimal” size of an object. While the disclosed system may use one or more factor values as default values for automatically resizing an object inserted in a given poster, a user may also adjust the factor values upon their will, in order to produce their own automated object “optimal” sizing rules. As a way of example, in case the user wants the method to automatically resize objects that are inserted, into dimensions greater than the width of a column of text, they may adjust the factor value to values greater than 1. Similarly, by adjusting the factor value to values smaller than 1, they will assure the disclosed method automatically resizes objects that are inserted into dimensions smaller than the width of the column. Summing up, by introducing the automatic object “optimal” size calculation method, including the “‘optimal’ size” and “factor” parameters, the user is provided with: a subsystem that automatically resizes user-inserted objects into dimensions that create an aesthetic and legible result; an interface by which the user may set their own rules for automatically resizing the inserted objects into dimensions that create a result the user likes. In other words, we provide an interface by which the user may determine their preferred “optimal” size of inserted objects. We note that the user may do so without the need for expert knowledge like utilizing advanced desktop publishing software or computer programming techniques.

For every object group arranging layout, the following method automatically calculates the “optimal” dimensions of both the overall groups as well as the individual objects. The method takes into account the column width as defined by the poster dimensions and a series of other parameters, including number of columns, margins and padding. Principally, the method ensures that an object or gallery of objects is placed inside a column of text in an aesthetical way. The disclosed software automatically calculates the necessary parameters of a collection of such objects. Provided are various methods that can be used for this purpose in the following. FIG. 12 is an example view of one of the methods utilized for the calculation of object width or object group width as a function of column width. FIG. 13 describes one of the methods by which column width (“CW”) is determined as a function of the number of columns, as well as margins and padding of the poster layout.

Next to or near every object inserted into the poster, the user may add a caption. Additionally, the user may add a legend for every group of objects, which constitute an object gallery. Therefore, the disclosed system makes it easy to insert multiple objects showcasing a sequence of concepts or data, and describe them one by one, as well as a whole gallery, through their accompanying legends. All aforementioned legends may contain text, equations or hyperlinks and may be placed beneath, above, left or right of the corresponding object, depending upon user's will. For every object gallery arranging layout a special algorithm is executed which determines the surface and position provided for the legend of each individual object. Hence, the legend text is automatically arranged and aligned at certain predetermined or user-determined positions next to its corresponding object, finally creating an aesthetical result while preserving the necessary visual relationship between each object, be it an image, graph, plot or multimedia, and its legend.

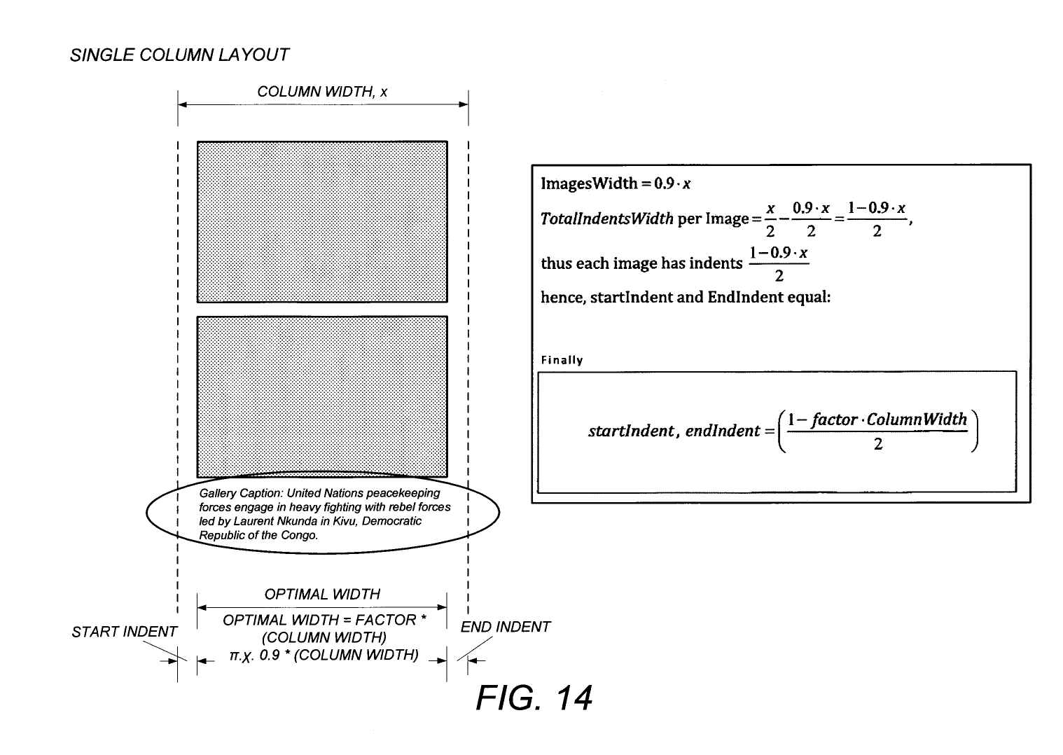

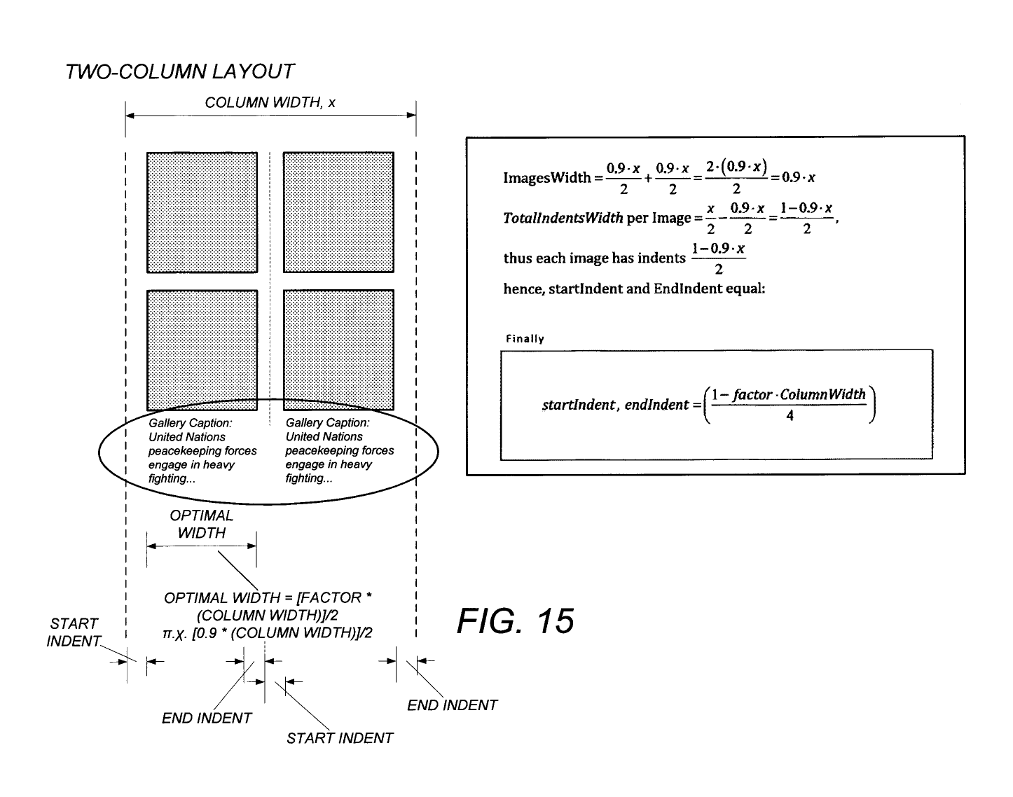

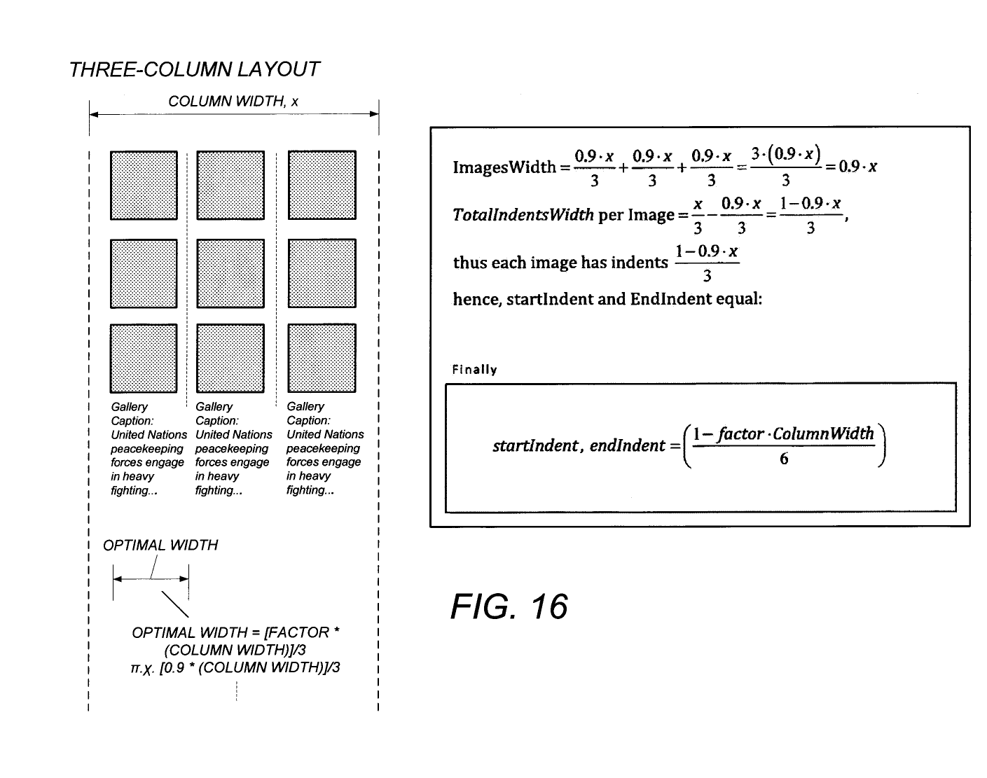

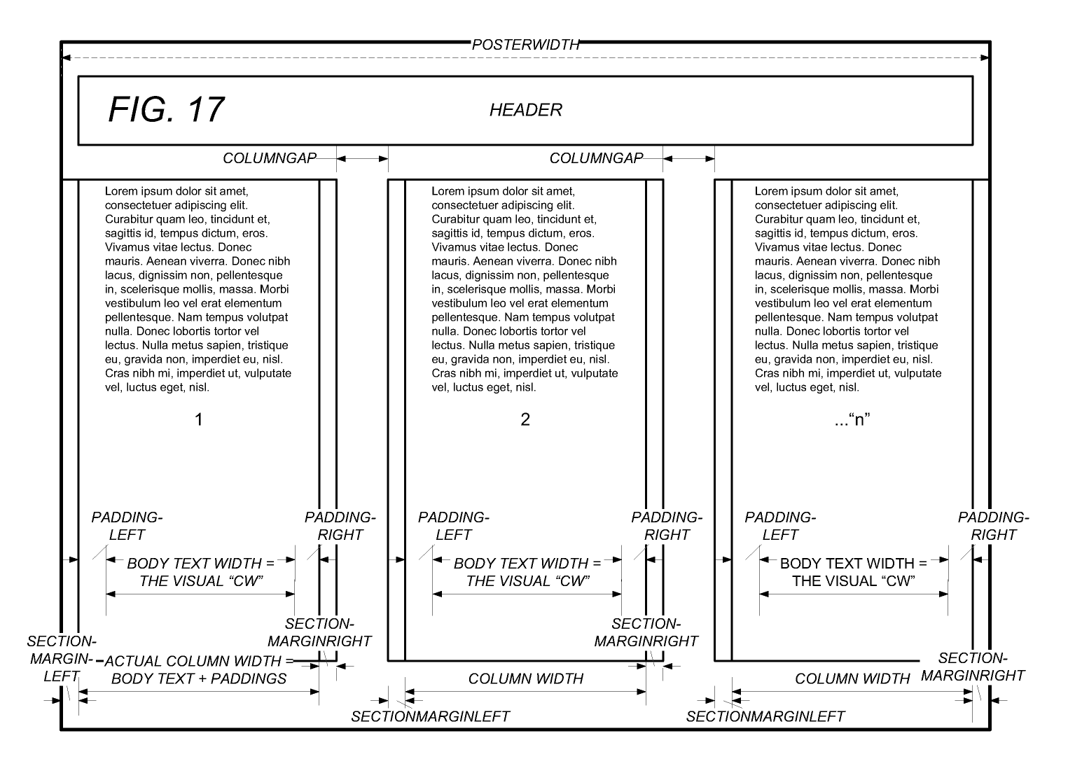

FIG. 14 is an example view of one of the methods of calculating positioning and alignment of object legend text, underneath its corresponding object, in the single column gallery layout case. FIG. 15 is an example view of one of the methods of calculating positioning and alignment of object legend text, underneath its corresponding object, in the two-column gallery layout case. FIG. 16 is an example view of one of the methods of calculating positioning and alignment of object legend text, underneath its corresponding object, in the three-column gallery layout case. FIG. 17 is an example view of various definitions utilized in the aforementioned methods.

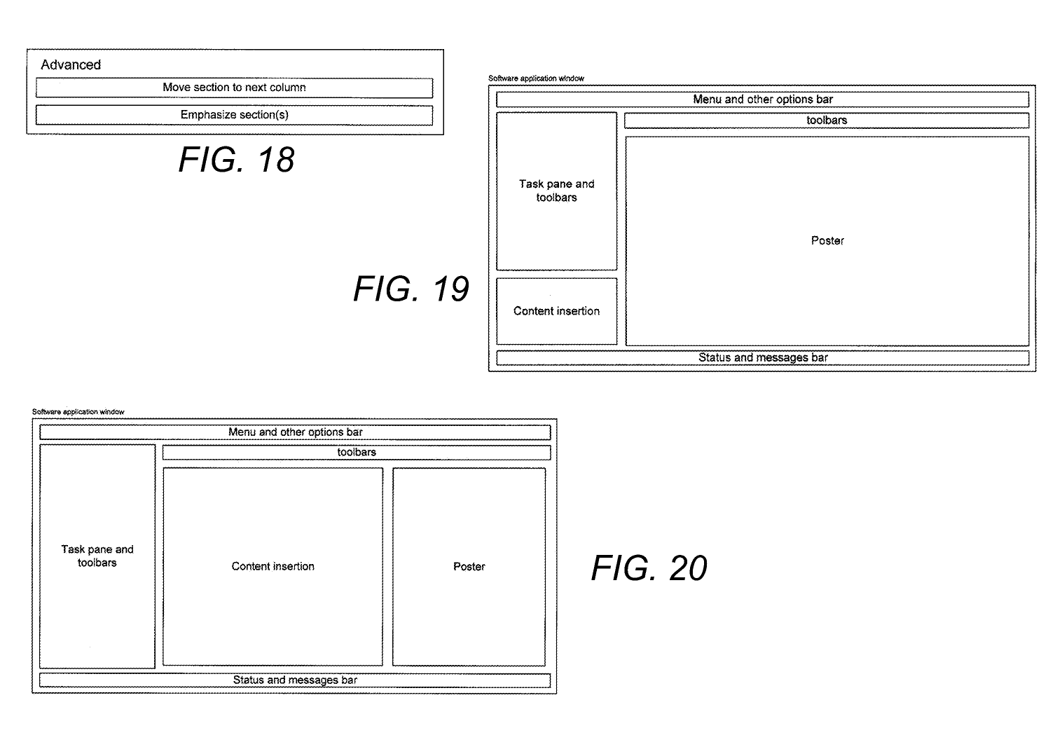

Advanced section adjustments are now discussed. To aid the arrangement of content into the poster, the user is provided with a way to move a section to another column or region of the poster with just a click. Furthermore, the user may select one or more sections to emphasize, that is to stamp them as a way of putting emphasis into their content. By way of example, the user may add specific formatting to certain sections, as a way to draw attention to their content. FIG. 18 is an example view of the advanced section adjustment options. By way of example, the sketch here refers to options such as moving a section from one column of the poster to another. At any time the user presses “save” and sees an updated version of their poster including the content the user has already inserted. To “save”, the user may either use the menu or the corresponding controls in the toolbar of the disclosed software application.

An easy to use task pane is provided from which the user can easily navigate through the poster contents, as well as delete and add new content. In addition to this, the user may browse through the available templates or access recent posters and open them. To provide further flexibility for the user, the task pane tabs may be minimized at any time, thus saving space, or may be restored to their original size.

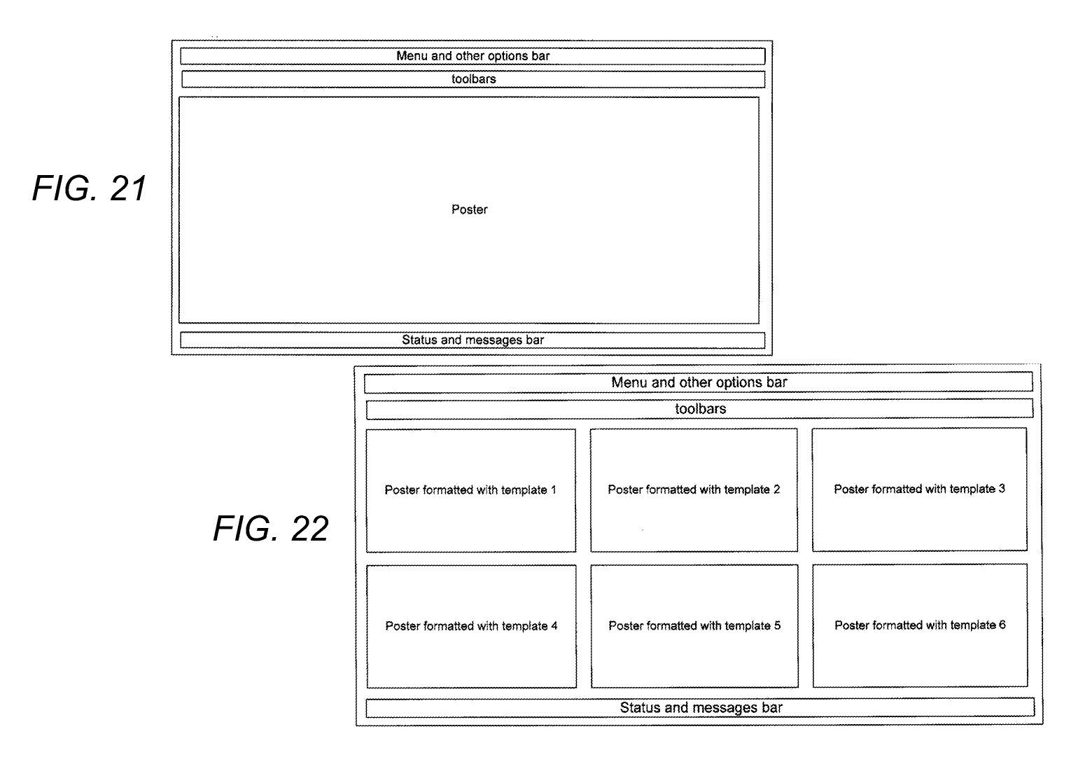

Multiple workspace layouts are now discussed. To aid the user in inserting content and best viewing the poster under creation, several workspace layouts are provided. By choosing one of them, depending on the monitor resolution and poster dimensions and orientation, an optimized workspace layout is provided. Specifically, for a landscape poster, the workspace is arranged in a way so that the area designated for viewing the poster under creation obtains a landscape orientation, similar to the one of the poster. Similarly, for a portrait poster, the workspace is arranged in a way so that the area designated for viewing the poster under creation obtains a portrait orientation, similar to the one of the poster. In each case the rest of the workspace, outside the area designated for viewing the poster under creation, is optimized for content insertion and arrangement, to aid the user's workflow. FIG. 19 is an example view of the workspace layout arranged to best fit and show a poster with landscape orientation. FIG. 20 is an example view of the workspace layout arranged to best fit and show poster a portrait orientation. At any time, the user may hide the task pane and content insertion tools, therefore having a full screen preview of the poster under creation. FIG. 21 is an example view of the workspace layout arranged to hide the task pane and content insertion tools, in order to have a full-view of the poster under creation.

The user may at any time apply more than one PCRIO, which may in some respects be thought of as a highly functioning “template,” to the same poster. Furthermore, the user may automatically adjust the workspace layout so that the various versions of the poster are shown simultaneously, by way of example, tiled one next to the other. As a result the user may easily compare all the different results and choose the one that better suits their needs or taste, among them. FIG. 22 is an example view of the workspace layout arranged to showcase several versions of the same poster, each of which is formatted with a different template/PCRIO, therefore aiding the user to easily compare them and choose one among them.

Provided in a related preferred embodiment by the poster generation tool 302 is the computer-assisted generation of a plurality of posters to be viewed at a respective plurality of scientific conferences, each poster satisfying a respective prepared configuration guideline previously established for each scientific conference. A first PCRIO corresponding to the first conference is accessed from a PCRIO database, which can be stored on the centrally located PCRIO database 324 or alternatively at the user's computer. Displayed to the user is a plurality of content section input frames is corresponding to a respective plurality of content sections specified by the content section constraints of the first PCRIO, the plurality of content section input frames being sequenced according to the content section sequence of the first PCRIO. Blocks of user-pasted or otherwise user-identified content data are received into respective ones of the content section input frames, the respective blocks of content data each including at least one media object and least one text segment. The received content data is then automatically processed to generate therefrom the first poster according to the content type, content section constraints, content section sequence, content spatial layout, and content formatting specified in the first PCRIO. The first poster is stored. An identity of a second conference for which it is desired that a second poster be generated is received from the user. A second PCRIO corresponding to the second identified hosted event is accessed from the PCRIO database. The first poster is retrieved and automatically processed to generate therefrom the second poster according to the content type, content section constraints, content section sequence, content spatial layout, and content formatting specified in the second PCRIO, thereby saving a substantial amount of user time and effort in creating the second document.

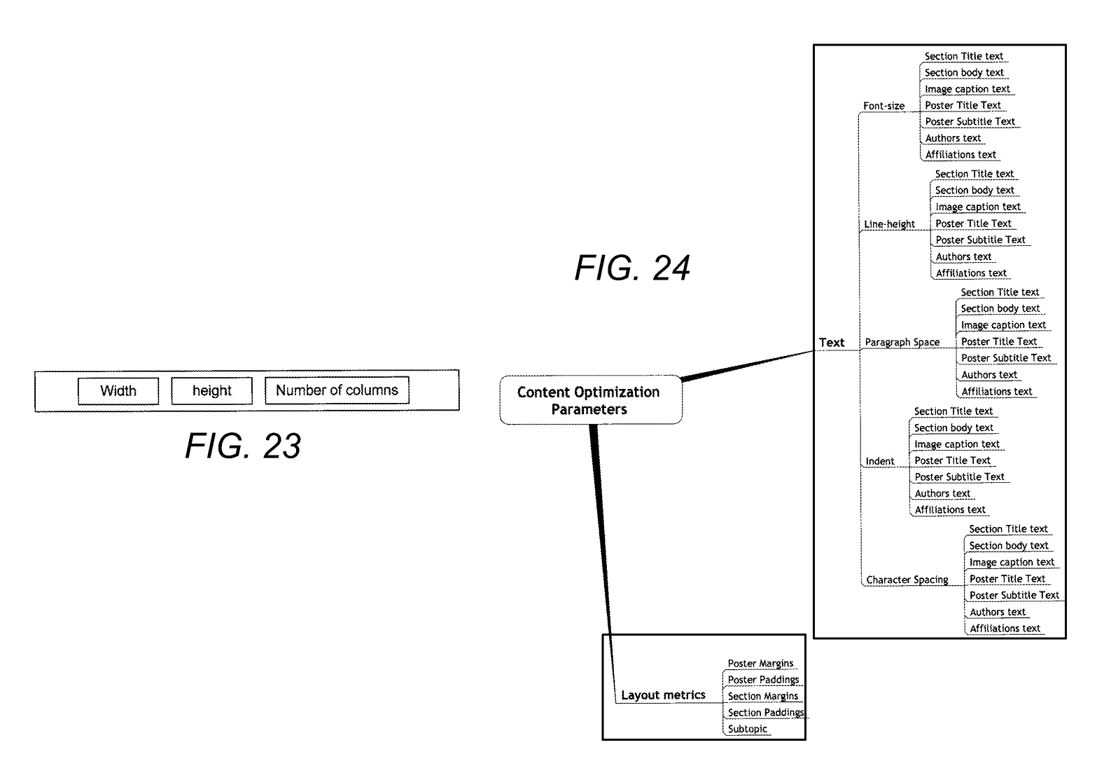

The changing of poster dimensions and number of columns is now discussed. At the user's discretion, the dimensions of the poster and number of columns can be changed by the designated toolbar provided in the disclosed software application. Rather than having to move blocks of text, images and other objects around, the disclosed software application will automatically lay them out in the new poster surface as defined by the change in dimensions or number of columns. FIG. 23 is an example view of the controls provided to the user to change the dimensions and the number of columns of the poster.

Content optimization is now discussed. After the user has finished inserting the content into the poster, the user may use a designated toolbar to optimize the poster so that the content best fits the available poster surface. Additionally, every time the user wishes to change the poster dimensions or number of columns, the content of the poster is automatically re-optimized to better fit the available poster surface. Both a manual optimizing and an automatically optimizing tool are provided.

Optimization takes place by a method which is incorporated in the disclosed software application. This method adjusts the values in a series of poster parameters in such a way so that the surface occupied by the content equals or closely approximates the available poster surface. Values included in the optimization method refer to both typographic as well as poster layout parameters. A method of prioritization is included in the optimization method, which arranges the order and range of values by which the various parameters may be adjusted. Furthermore, values in certain parameters are interrelated with values in other parameters, and once the content optimization procedure is implemented, these values change while maintaining their ratios. As an example to illustrate our optimization method, suppose that at a given part of the poster the parameter ‘font-size’ may come predefined by the used template in a value of “x”, while the line-height, which also comes predefined by the same template is “1.25·x”. Upon applying the content optimization method, the values in the two parameters do not change independently from each other, but instead change in a way so that their ratios are maintained precisely or approximately in order to preserve the way their block of text appears. The approximation by which their ratio is to be maintained can be adjusted through a series of sensitivity settings provided as preferences for the user. Hence, the content optimization method ensures that values to be adjusted will be done in ways that maintain an overall aesthetical result for the poster under creation. FIG. 24 is an example conceptual view of some of the parameters utilized for the fine-tuning by which manual or automatic optimization of content into the available poster surface takes place.

Formatting of the poster into a professional looking design is now discussed. The disclosed software application allows description, both in syntax and semantics of all relevant parameters used for the creation or formatting of a poster in a digital record, for example, the PCRIO 322 supra. Such digital record can be stored and retrieved by the user. For purposes of the discussion hereinbelow, the PCRIO 322 can be thought of as a highly functioning type of “template”. In addition to PCRIOs specified by particular conferences, the discussed software application can also provide a variety of pre-existing PCRIOs or “templates”. The user may browse through a library of professionally designed poster templates to pick the one that best suits their needs.

A template is a digital record that can be stored as a file, specifically designed to carry information that determines the layout and design of a poster. The structure of a template file is such that the information it carries is applicable to the content of a poster, independently of the poster's dimensions and orientation. Furthermore, the structure of a template file is such so that it does not interfere with the user-inserted poster content. Last but not least, the template file is structured in such a way so that the way it formats a poster remains unaffected by additional content which may be added to the poster or subtracted from the poster.

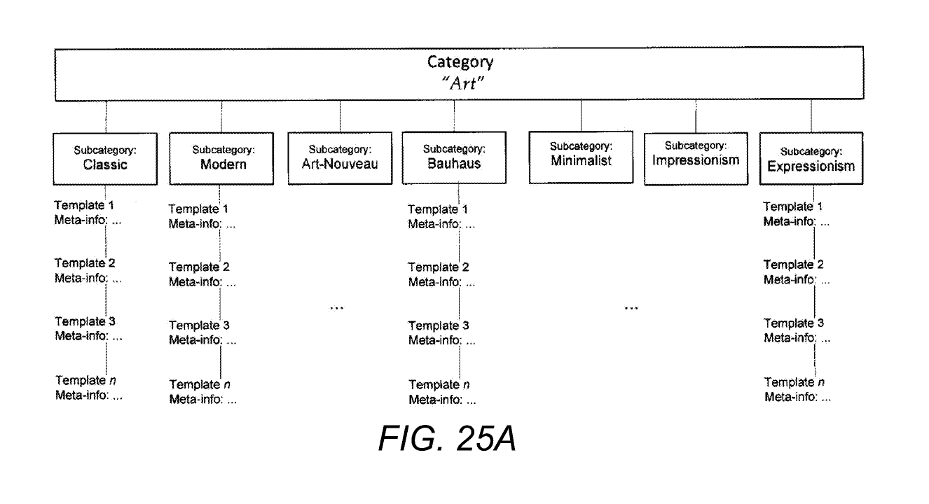

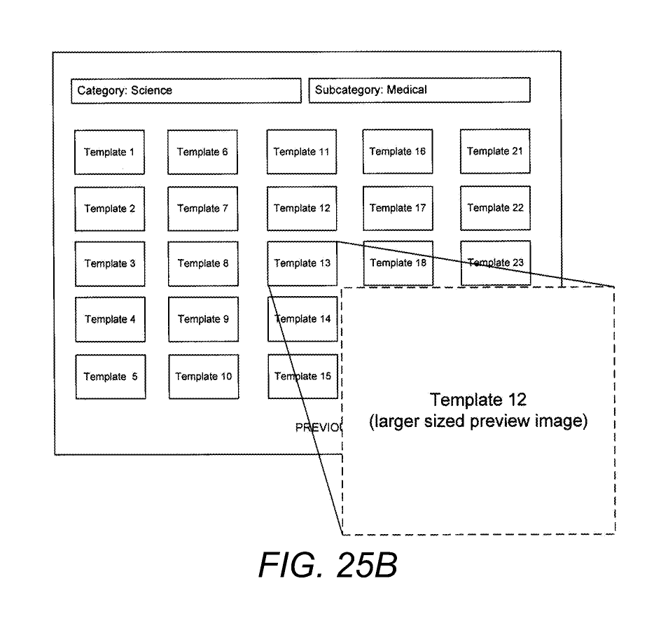

The templates come organized in thematic categories, classified in groups or packages and sub-groups or families. Each package refers to a topic or category, be it either a professional field, e.g. “Medicine” or a concept e.g. “Art”. Categories of templates comprise of subcategories. Each subcategory refers to a subtopic or sub-group of the corresponding topic, e.g. for the “Medicine” package, each family may refer to a medical specialty, like “Anesthesiology”, “Surgery” etc., while for the “Art” package, each family may refer to a specific art e.g. “painting”, “music” etc., or a style, e.g.: “impressionism”, “art nouveau”, etc. All information regarding the classification as well as additional information is included in descriptive data that escort each template (metadata). The aforementioned classification allows the user to browse for templates of a particular subject that relates to the subject of the poster (e.g. “medical” for doctors) or for a particular style that relates to the aesthetics they prefer (e.g. “abstract art”). Therefore the user may quickly search exclusively among templates that interest them or are suitable for them, and easily find templates that best fit their needs. FIG. 25A is an example view of the concept behind the classification of poster templates into thematic categories therefore allowing the user to browse for templates of a particular subject or for a particular style. Here, an example sketch of a template category referring to topic Art is presented.

The user accesses these templates through a designated template library area in the graphical user interface of the disclosed software application. The user can have an impression of the look of a poster formatted with each template, by seeing thumbnails of the templates with or without sample content. To have a clearer impression of the look of a poster formatted with each template the user can also see a larger ‘preview’ of each template, also with or without sample content.

Further customization of poster design by use of effects is now discussed. The user may select among a series of poster-region-specific templates, to further adjust the design of the poster. These template effects are applicable to individual parts of the poster such as a section. For example, an effect may consist of a background graphic, a different font-family, and a variety of font-colors that can be applied solely to selected sections. By utilizing these template effects, the user may alter the original template used for formatting the poster, therefore introducing differentiation of the poster from other posters. By using the template effects, the user may change background graphics in the different poster regions, the color palette used in the poster, font-families, borders and other decoration elements. As a result of the above, these template effects are of utmost importance on expanding poster design variability. For example, two users creating posters independently from each other may create a poster with the same template, however by importing their own background graphics and applying different effects on parts of the poster such as the header and section titles, the two users eventually end up with vastly different looking posters. The end result is that with a library of n templates with m effects, a combination of nm different looking posters may be created.

An important feature of our method is the ability to receive information from a centralized database regarding how many other attendees of a specific event have utilized a certain template. As such, when preparing a poster for a certain event, the user can receive information on the number of times each template has already been used for this specific event. This aids the user to avoid choosing a template that has been used extensively and helps achieve differentiation of the poster from others in the event the user is planning to attend. The user may expand the library of their templates by purchasing additional ones from the production company, or authorized third parties. FIG. 25B shows an example view of the template library, in which the user may choose among a series of templates which are organized in thematic categories: here, a package dubbed “Science” has been chosen, out of which templates that follow into the family “medical” is shown.

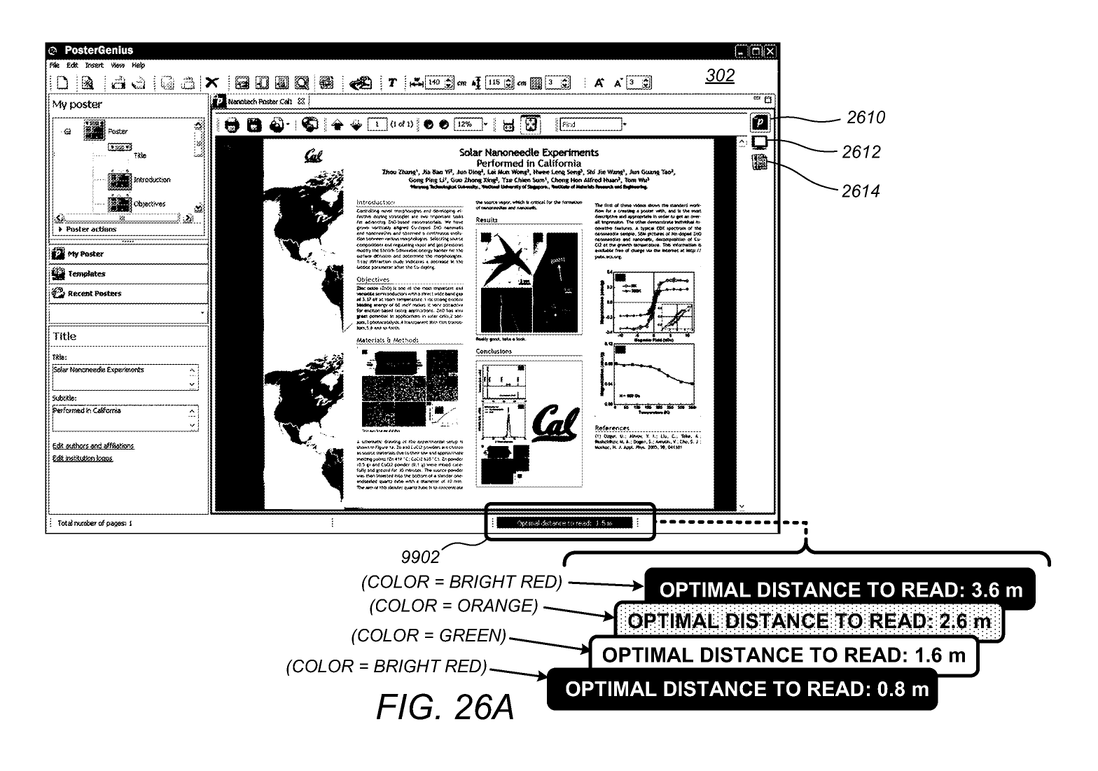

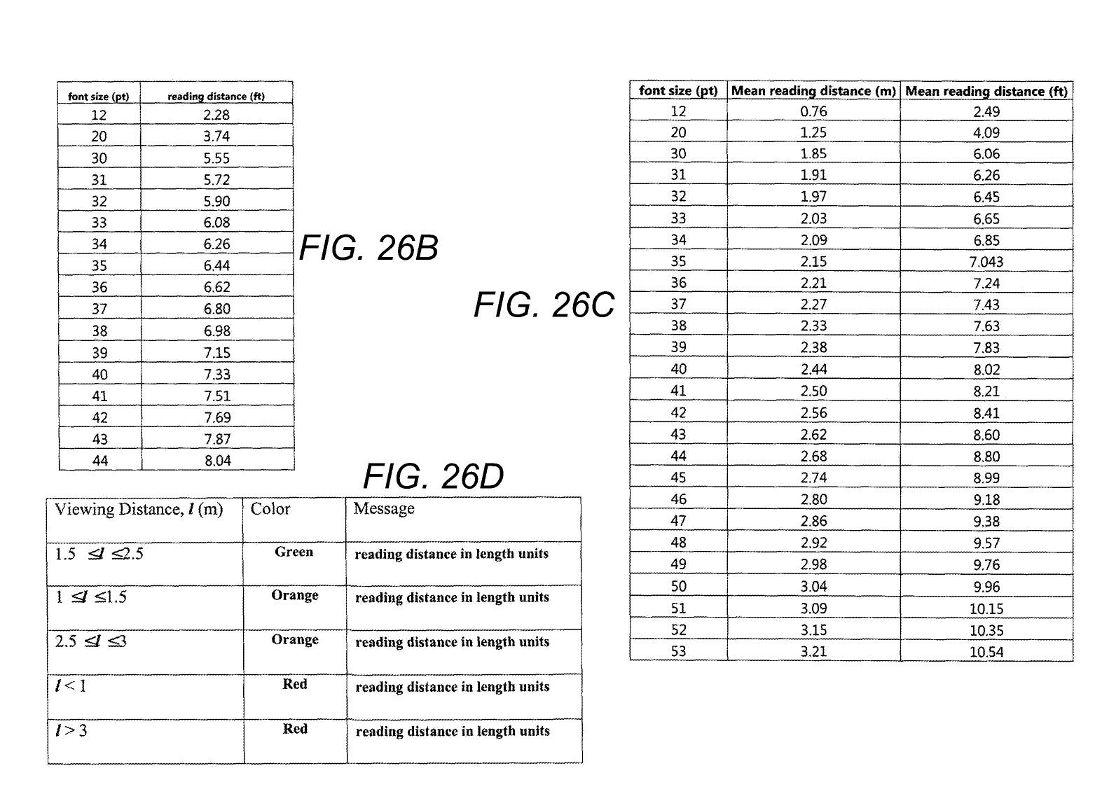

FIG. 26A illustrates a user interface of a poster generation tool including an optimal viewing distance indicator functionality and a media-specific poster adaptation functionality according to a preferred embodiment. FIGS. 26B-26C illustrate optimal reading distance tables associated with the optimal viewing distance indicator of FIG. 26A. FIG. 26D illustrates a color coding table associated with the optimal viewing distance indicator of FIG. 26A. A common problem encountered when creating scientific posters according to the prior art is that the author rarely knows how large the text should be in order to be readable from a typical distance that other event attendees would be standing in the hall where the event is taking place. Usually, the poster author has to go through extensive trial and error to find out a proper size of typographic characters. This is both time consuming as well as risky, since until the user has a look at the final printout, the user will never know that the content is actually readable at the appropriate distance.

With the disclosed software system, at any time during the process of creating the poster, the user may assess in real-time the distance by which the content of the poster will be comfortably readable in the event hall. The calculation is made by a specifically designed method, which is based on a collection of scientific conference and event guidelines and data from opthalmological research. This feature is of utmost importance for the poster author as it ensures that the content will be legible from the typical distance an attendee would be standing in order to read posters in the event hall. Furthermore, it also implies that the user will not need to carry out their own experimentation with different font-sizes in order to achieve the desired result, which results in saving both time (for the various trials) and money (for trial printouts). The various tables, figures, plots and formulas that follow are example implementations of our method, which have yielded very good results when tested on a number of posters and other printed documents. However, our invention is applicable to all displaying mechanisms, and the tables, figures, plots and formulas below are in no way restricting the scope of our invention. We are providing the method and various systems of producing such tables, figures, plots and formulas that can be used for other such applications.

Method for calculating reading distance is now discussed. A number of posters are printed in physical dimensions (1:1) and hanged on board. A variety of fonts are used in a variety of font-sizes across the posters, one font in one font-size per poster. A statistically sufficient number of viewers (hereafter “testers”) are asked to face the posters standing at the distance from which it is easiest for them to read the poster's content. For every tester, this distance is logged as the “ideal” distance, hereafter “reading distance”. A dataset is thus created which contains, the reading distances for every tester and for every font-size used in the poster content. A qualitative view of this dataset looks like the data in FIG. 26B. FIG. 26B is a qualitative example of the dataset created which shows the distance from which a poster's content may be read.

Descriptive statistics are calculated for the distance values including, mean values and standard deviations, as well as the distribution of values. Following, a statistically robust mean reading distance is calculated for all testers, for every font-size. FIG. 26C is a qualitative view of the calculated mean reading distance, as derived from the total number of testers, from which a poster's content may be read. Having a dataset of discrete values for font-size and mean reading distance, and using fundamental statistics an equation is produced, which describes the mean reading distance as a function of font-size, i.e., Reading Distance=f(Font-size). A method that utilizes this relationship is used, which reads the font-size used during the poster creation or adjustment process and automatically shows the reading distance to the user. On every change of font-sizes, the system updates the reading distance and shows the updated value to the user. Consequently, the user is at all times during the poster creation process informed of the distance by which the poster's content is comfortably read.

In a typical, conference-style event, it has been empirically shown that the best distance for an attendee to stand from a poster lies within a range of distances. This range of distances may vary depending on a number of aspects such as: that closer from this range of distances it is usually difficult for an attendee to have an overview of a poster; that further from this distance it is difficult for the attendee to read the poster; the available space in usual event hall corridors; the occasionally big number of attendees that might gather around a poster to read and discuss; and the potential presence of the poster author(s) in the vicinity of the poster, in order to explain or discuss certain parts of the poster. By way of example, in many cases this range of distances lies between 1.5 and 2.5 m. In other preferred embodiments, this range is (i) adjustable by the user, (ii) specified by the PCRIO 322, or a combination of (i) and (ii).

Communication of reading distance results obtained through the aforementioned method to the user through the Graphical User Interface may be performed through a number of ways. For example, the reading distance value may be shown. Furthermore, a color indicator (see FIG. 26A) may be utilized as a way of notifying the poster creator whether the font-size the user has used results in a reading distance which is too far or too close to the poster, that is, further or closer from the range of usual distances mentioned above.

By way of example, with reference to a viewing distance indicator tool shown as element 9902 in FIG. 26A, the following is an example showcasing how this information may be communicated to the user. When the font-size utilized in the poster lies in a range of values that lead to a range of reading distances within the [1.5, 2.5] (m) range, which has been used as an example above, the indication of the reading distance appears with a certain color, for example, on a green background, therefore informing the user that the font-size is appropriate. If the font-size being used is increased or decreased to values that lead to reading distances smaller than 1.5 m, but not less than 1 m, or larger than 2.5 m, but not more than 3 m, then the indication of the distance to read appears on an orange background, therefore informing the user that the user should ideally consider decreasing or increasing the font-size accordingly. Similarly, if the font-sizes used lie in ranges of values that lead to reading distances closer than 1 m or further than 3 m from the poster, when reading capability becomes nearly impossible, then the indication of the reading distance appears on a red background, therefore informing the user that considerate is imperative to decrease or increase the font-size accordingly to make the poster better readable in the event hall. In other preferred embodiments, all of the above numerical ranges are (i) adjustable by the user, (ii) specified by the PCRIO 322, or a combination of (i) and (ii). FIG. 26D is an example view of one among the ways the reading distance is presented to the user, to facilitate the identification of possible need for font-size adjustments, so that the poster is comfortably readable in the event hall.

Notably, the disclosed method does not rely on the exact choice of viewing distance thresholds; these thresholds can be adjusted according to the target displaying mechanism (printing vs. electronic displays), event hall size, lighting, etc. Consequently, the range of values [1.5, 2.5] (m) utilized above is solely for the sake of clarification. The choice of color-coding of viewing distance information is also configurable by the user and can also be changed to a grey-scale or texture-based coding mechanism and such.

On-screen presentation for review of content. A common problem when creating scientific posters is that due to their large size format, as well as the consequent size of letters, graphs and plots, it is difficult for the user to browse through and review the poster content on-screen. With the disclosed system, the user may at any time during the poster creation process enter a special mode for reviewing the content, be it text, images, graphs or multimedia by using a specifically designed feature for best on-screen presentation of content. Specifically, at the user's request (see FIG. 26A, control input 2610), the disclosed software application instantly formats the poster in a page-layout that best fits the workspace layout. For example, regardless of the poster's actual dimensions and orientation, the disclosed system lays the content out into a page of such dimensions, so that the document is zoomed to best-fit to all the of the available on-screen Graphical User Interface space.

For one preferred embodiment, an advantageous combinations of the following functionalities is provided. Responsive to a first user request (see FIG. 26A, control input 2610), the poster is rendered in real time and a viewable version thereof is displayed in a manner scaled to fit onto a predefined display area. Responsive to a second user request (see FIG. 26A, control input 2612), the content data is automatically reformatted to facilitate a guided user navigation through the poster content on at least one of a section-by-section basis and media object-by-media object basis. Responsive to a third user request (see FIG. 26A, control input 2614), the content data is automatically reformatted to generate therefrom a small-scale version of the poster content suitable for printout and distribution to the community of human viewers. For another preferred embodiment, the advantageous combination further includes, responsive to a fourth user request, automatically reformatting the content data to generate therefrom a web site featuring the content data, the web site including a hyperlink structure based at least on part on the content section constraints specified in the PCRIO 322.

Also provided is a series of automatic features that facilitate easy navigation are provided such as links for easy and fast navigation through the content, section-by-section or image-by-image etc., so that the user may comfortably identify possible mistakes and correct them. FIG. 27 is an example view of a portion of the user's content formatted for on-screen presentation, in order to aid fast and easy review and corrections. The display of FIG. 27 can be actuated by the user by virtue of the control button 2612 of FIG. 26A. We denote that context appearing is randomly chosen and serves exclusively as a way of facilitating the description of the concept at hand. Our method has been designed to work independently of the actual content used by the user.

Document-to-poster conversion is now discussed. With the disclosed system, the user has an additional option for the poster creation process. Instead of using any of the aforementioned workflows, the user may directly convert the document containing the submitted manuscript, be it an abstract or paper, into a poster, by utilizing yet another highly innovative method developed as part of the disclosed system. Specifically, this method scans the document and identifies the beginning and ending of sections comprising the document. To do so, it utilizes a built-in database of typical keywords, such as section titles or parts of section titles, which are common in academic publications (e.g. “results”, “materials and methods”, “objectives”). If the user has typed section titles that differ significantly from the ones commonly used in academia, the method allows for insertion of custom section titles. Following this, the method marks the beginning of a section starting with a section title until the next point where a section title is detected. Any content, be it text, images, graphs, plots and multimedia, detected between the points marking the beginning and ending of the section is considered the section's content. As a result of the above, the method allows our system to create the content structure of the poster, which includes the various sections with their individual content. In the last step of the document-to-poster conversion process, the method automatically inserts the content identified in the document into the poster. All sections are laid out in a way similar with the manual insertion procedure described above, and are arranged as determined by the user's chosen template.

Finalization of poster creation in terms of saving, sharing, printing, and showcasing is now discussed. As soon as the user feels the poster is ready for print, the user is provided with several options on how to proceed. Several options for saving the poster are provided; among them saving into one of many popular formats, such as the ubiquitous pdf format which can be submitted to the recipient for both printing into a hard-copy and on-screen previewing. To do so, the user may save from the aforementioned controls in the toolbar and the menu.

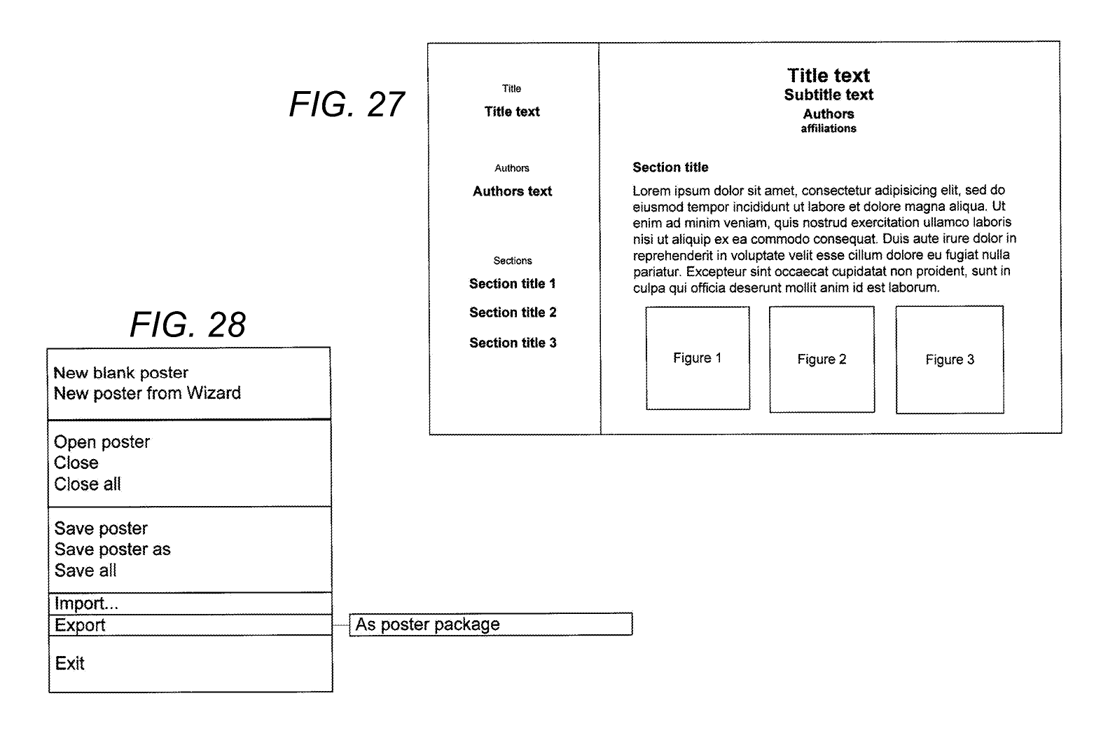

Another option is to save the poster into the software application's native format. This format is a compressed package of all of the individual source files constituting the poster, including any text, images, graphs and multimedia, as well as all the programmed code that arranges the design and layout of the poster. This format is fully portable and fully adjustable, upon review, by anyone having the disclosed software application installed on their computer. Therefore, this feature is of utmost importance in that it aids collaborative authoring work on a poster by a team of people. To save into this format the user may use the menu. FIG. 28 is an example view of the options the user is provided with upon saving the poster.

Following poster creation, the user may send the poster for print in the original size, provided the user has access to a large-format plotter printer, or scaled to any standard office printer. Poster Printing & Shipping Service. In addition to the systems and methods described for the creation of a poster, we describe a method to transfer and visualize the poster at the final event location. Rather than having to find a printing service and arrange for the poster to be printed, the user may utilize a printing & shipping services feature included in the disclosed software system. Based on a number of factors, like location of poster's creator (user), destination where poster is to be sent, poster dimensions, timeframe within which the poster has to be printed and delivered, shipping method, and additional services (e.g., to be mounted on the poster-board in the event hall or not), the user gets a report for best prices among which the user may choose the best. By choosing and paying for one of the available services, the user may have the poster printed, delivered and mounted on a certain date at a certain location around the globe, in due time for the poster presentation.

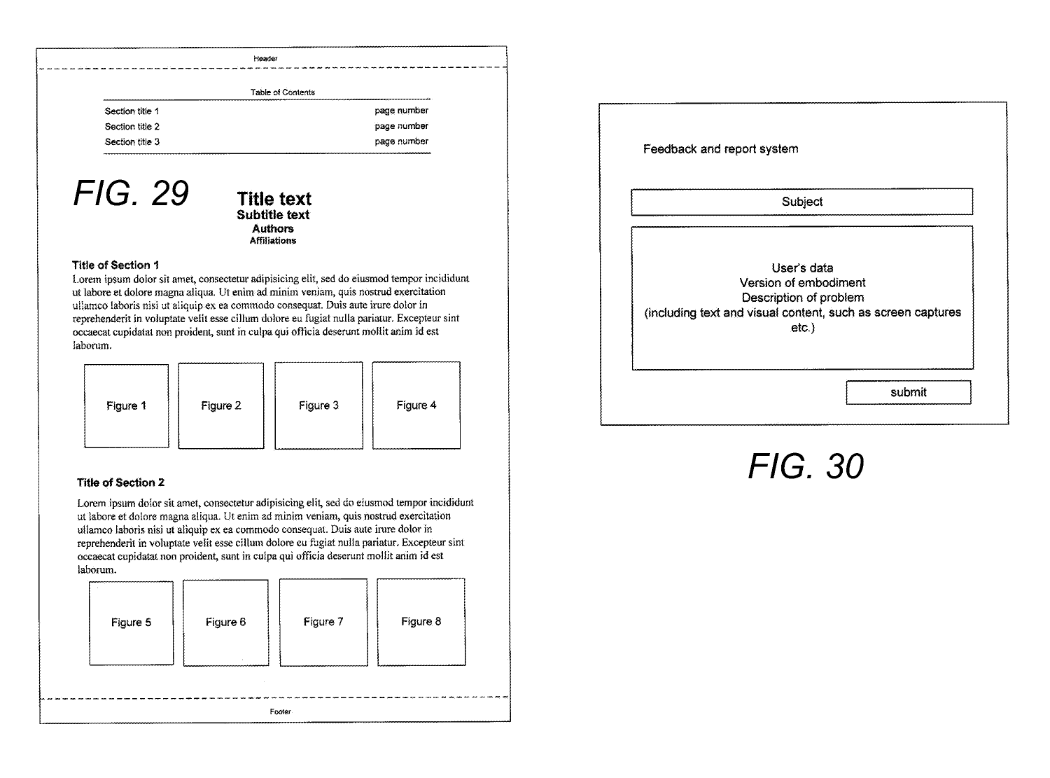

Instant creation of distributable poster content hardcopy printouts is now discussed. In addition to the above, the user may wish to make printouts of the contents of the poster in A4, Letter-size (8.5″×11″) or any standard page dimension, for distribution to fellow researchers, classmates, students and/or fellow conference attendees. Using other applications, a user typically down-scales the poster to fit into any standard page size used by regular office printers, with the content being nearly illegible. On the contrary, with the disclosed system, the user can instantly create an elegant, optimized for small-format printout document which is formatted in a way similar to a journal paper, and is highly readable. To achieve the aforementioned conversion, the disclosed system utilizes specifically designed templates and adjusts the user-input content into the layout of any standard page dimensions. FIG. 29 is an example view of the user's poster formatted as a journal paper-like printout for distribution to colleagues, classmates, fellow event attendees, etc. The display of FIG. 29 can be actuated by the user by virtue of the control button 2614 of FIG. 26A. We denote that context appearing is randomly chosen and serves exclusively as a way of facilitating the description of the concept at hand. Our method has been designed to work independently of the actual content used by the user.

Dynamic posters for LCD/Plasma display presentation are now discussed. Using the system described, the user may also create a fully dynamic poster that can be presented in large electronic display, such as LCD or Plasma displays. The way the disclosed software system handles the LCD/Plasma display presentation offers flexibility in a series of aspects. Specifically, by using scalable representation, such as vector technology for the text, plots and graphs rather than bitmaps, the disclosed software system allows for lossless quality of all text, graphs and plots while it also includes interaction with the user for best presentation of content. Additional features provided include the capability to incorporate video and animation objects in the poster content, including the possibility for interactivity with the poster viewer. This further maximizes the poster authors' capability to convey their message and results. Furthermore, the user may accompany the poster with a textual or multimedia presentation of the group of poster authors, their affiliation data, professional/research background as well as any announcements they are interested in making in the conference/meeting hall. Therefore, the disclosed system transforms regular scientific poster creation into a multi-level presentation of research groups and academic institutions.

Dynamic and interactive poster creation and scientific event management are now discussed. The disclosed system features a series of methods and provides possibilities that go along with dynamic poster creation. Specifically, the disclosed system can connect with a central server managing a conference or other event, for easy electronic submission of a poster to the event organizing committee. This minimizes workload for both the poster creation and the organizing committee. Following that, and upon the committee's review of each poster, posters are arranged in thematic categories and the date, time and duration of their presentation is automatically arranged to the LCD/Plasma monitors that will be available in the conference hall. Upon arrangement, the scheduled date, time and duration of their presentation is instantly submitted to the poster author for their information regarding their presence in the poster session.

According to a preferred embodiment, provided is a hosting server that facilitates the hosting of a conference at which a plurality of electronic posters are to be displayed in a respective plurality of electronic poster presentation sessions, each electronic poster presentation session to take place at one of a plurality of distinct poster presentation stations provided in association with the conference, each having a dedicated LCD/plasma monitor or other display device. Each of the plurality of electronic posters to be displayed is received and stored. Scheduling information is received indicating, for each of the electronic poster presentation sessions, a designated time interval therefor and a designated one of the poster presentation stations at which the associated electronic poster is to be displayed. For each of the electronic poster presentation sessions, the hosting server causing the associated electronic poster be displayed at the designated poster presentation station during the designated time interval.

The aforementioned capabilities are highly advantageous for the user for at least the following reasons: the user submits the poster to the event organizing committee upon creation and electronically; the user does not need to printout the poster, which minimizes poster creation cost, while it is also environmental-friendly; the user does not need to carry the poster with them on the way to and from the event; the user does not need to mount or remove the poster; the user is electronically notified upon receipt of the poster, as well as upon the exact place and time the poster will be presented in a pertinent LCD/Plasma display, so that the user arranges their presence there; all scientific results announced in an event (e.g. a conference) will be possible to be stored in digital media and be distributed to the event attendees, therefore improving dissemination of state-of-the-art knowledge among researchers; and the user will have the chance to use a single piece of technology to present the results of their research together with a collection of “metadata”, such as a general presentation of their professional field, their research background and curriculum vitae, collaborations with colleagues and institutions, professional aims and objectives. This presentation might include video and multimedia and will be interrelated with the individual event presentations and/or publications included in the database.

The aforementioned methods are highly advantageous for the research/scientific/academic community for at least the following reasons: it is possible for event proceedings to be stored in databases interrelated with accompanying “metadata” information regarding the research groups participating in the pertinent events; a researcher/scientist/academician will be able to either browse the database by thematic categories or search the database for specific research/science/academic topics, and/or metadata on individual researchers/scientists/academics or their groups through the disclosed system. Therefore, such a database collaborating with the disclosed systems present in the computers of individual users will constitute a communication platform for the international academic/research/scientific community. Furthermore, the aforementioned capabilities are of utmost importance for the event organizing committee as the poster session of the event is managed automatically a central server that collaborates with the disclosed systems installed in the computers of individual users, therefore taking the burden of managing time-scheduling of poster presentations from the organizing committee. Advantageously, the quality of presentations of scientific results will be improved by the large-scale use of video, animation and multimedia. Moreover, all scientific results announced in an event will be possible to be stored in digital media and be distributed to the event attendees, therefore improving expansion of state-of-the-art knowledge, while constituting a further attraction for the scientist/researcher to attend an event.

Other outputs of poster content in terms of websites and e-posters are now discussed. According to another preferred embodiment, the user may save the poster with all contents and design included as a website. A sitemap of the website is created, which links the title of each section to the corresponding webpage where the section's content is. Furthermore, links are created to link to short web-based presentation of author(s) participating to the poster's creation and the affiliation they come from. Therefore, with the disclosed system, we provide a method for the regular scientific poster creation process to be transformed into a web-based presentation of research results and findings, research groups as well as academic institutions. Last but not least, for the researcher/scientist who is planning to attend an event where their work will be presented as an e-poster, a specially designed submission form is also available, which the user may use to submit the poster to the event organization and/or reviewing committee. The user may at any time report bugs, problems, ask for features or submit questions to the system manufacturer's headquarters through an easy-to-use graphical user Interface form. FIG. 30 is an example view of the easy to use feedback report system that is available for the user.

The many advantages of the disclosed software application and disclosed system are now further described. In terms of business logic and workflow, there is provided substantial isolation of the content from the layout and design; at any part of the poster creation process, the user may focus solely on the content, without worrying about anything regarding formatting or presentation and let the application create or guide the aesthetic design. The easy to use poster creation wizard guides the user through a few easy steps to create his/her poster. A periodically updated database of guidelines of document preparation for certain events, by way of example, scientific conferences, including guidelines for document preparation, such as poster dimensions, orientation, standard section titles and other specifications eliminates the need for the user to manually read and periodically refer to the conference instructions and thus comply with them.

With regard to the automatic mechanism for the insertion of authors, affiliations, and abstract or paper selected information, instead of having to type each author and affiliation one-by-one, the user may simply copy all authors and affiliations as a simple paragraph from their submitted abstract and paste them into the disclosed application. The disclosed application reads through the paragraph of pasted text and automatically recognizes and separates authors and affiliations from each other, while matching each author with their corresponding affiliation. Each author is marked with a letter, number or symbol.

A rich text editor is provided supporting all standard text formatting used for scientific publications, including bold, italics, underline, strikethrough, super- and subscript, bullet and numbered lists. Furthermore, insertion and typing of equations is supported. A variety of workspace layouts is supported. Depending on the size and resolution of the user's monitor, as well as on the dimensions and orientation of the poster under creation, the user can choose one of the available workspace layouts to aid in the workflow. Content quick review on a single click transforms a poster into a document which is optimized for fast and easy on-screen review, with section and image bookmarks for fast navigation through the content. Distributable poster content hardcopy printout on a single click transforms a poster into a ready-to-print, document of A4, Letter or any standard page size, depending on the users' location and localization preferences. This hard copy features all the content of the poster formatted in a journal paper-like style, aimed for distribution to the event attendees.

In term of the graphical user interface of the disclosed software application, an easy to use task pane is provided from which the user can easily navigate through his/her poster contents, as well as delete and add new content. In addition to this, the user may browse through the available templates or access recent posters and open them. The tabs constituting the task pane may be minimized at any time, thus saving space for the user. Toolbars are provided from which the user can change perspectives, adjust poster dimensions and number of columns, optimize the poster, cut, copy, paste and delete content, as well as save all or each of the open poster(s) and create a new blank poster or bring up the wizard to create a “new poster from wizard”. Multilingual user interface (UI) translation is supported, based upon user's localization preferences.

In terms of business logic automations, a poster optimizer adjusts all values needed (e.g. typographic parameters, images size etc.) so that the user's content fits in the available surface of the poster. The size of characters and all other typographic parameters (including line heights, paragraph spaces, indents, margins and padding) is automatically arranged by the disclosed application. Hence, the user does not need to manage issues such as inputting font-sizes etc. However, in case the user wants to manually adjust typographic parameters themself, this capability is provided, as well. Upon every change of poster dimensions and/or orientation, the disclosed application automatically readjusts all input content into the available surface of the poster. As a result, the user may easily and instantly transform a poster created according to the guidelines of a certain event, into a poster complying with the guidelines of another event. With regard to the above-described reading distance indicator (optimal viewing distance indicator), based on opthalmological research data, a method specifically developed for the disclosed system facilitates automatic calculation in a way to inform the user, for any given values of the poster's typographic parameters and in real-time, regarding the distance from which the content of the poster is comfortably readable. The user can insert images one-by-one or multiple images at once from the file system, or input images/plots/graphs from the clipboard by pasting directly from the original applications where they were created. Thus, the user does not need to take the time to save their graphs, plots, maps, images, and so on in certain file formats and care for compatibility issues with the disclosed system. Images are grouped in collections of images which are resized automatically based on poster dimensions and typographic values. A series of predefined layouts let the user produce impressive image groups with just one click.

Based on the methods described for the disclosed system, a subsystem observes poster dimensions, number of columns and other parameters and automatically calculates “optimal” sizes for each of the poster's images and for each of the poster's groups of images. The subsystem is activated every time a user inserts a new image or changes poster's dimensions or number of columns. Newly inserted images are by-design placed with dimensions adjusted to optimal values. Depending on the template chosen for the formatting of the poster, individual image group styles are also applied to all image groups within the poster. These image group templates include different image layout arrangements, caption decorations, a variety of border styles, widths, colors etc. Support for the insertion of multimedia into the poster (e.g. sound, videos etc.) is provided.

The templating system described above allows for the unique capability of the disclosed system, that the same poster content may be arranged in totally different layouts and formatted with totally different designs, in a matter of seconds. The disclosed application comes with a gallery of professionally designed templates, which are applicable to posters of widely different sizes and/or dimension ratios. The templates are organized in thematic categories, each of which refers to a certain topic. These categories consist of subcategories. This classification allows the user to browse for templates of a particular subject that relates to the subject of the poster (e.g. medical for doctors) or for a particular style that relates to the aesthetics they prefer (e.g. abstract art). With regard to template effects/styles, a series of sub-templates is provided. These templates are applicable to individual parts of the poster such as a section. By utilizing these template effects, the user may alter the original template used for formatting the poster therefore introducing variations to achieve differentiation of the poster from other posters. Among the effects supported are a) the change of background graphics in the different poster regions, b) change of colors, c) change of all font-families, d) change of borders and other decoration elements etc.

The disclosed system keeps track of all created posters regardless of where they are stored in the user's data storage subsystem. Depending on the users' selection, the system may show all posters created with the disclosed application, or, for example, the most recently created or opened or modified posters. The system is very flexibly in that it allows the time period used for “recent posters” searching to be adjust by the user. The disclosed application provides the flexibility to search and filter among existing posters with user-defined criteria. The disclosed application supports export into a ready-for-print file in a multitude of existing popular digital file formats, such as the ubiquitous pdf format, which is easily distributable. The disclosed application allows for saving into its native file format. The system's native file is a completely portable, fully adjustable file, containing all of the poster's content as well all the elements of the users' last selected template: graphics, fonts, layout, and design metrical values. The disclosed application is the first of its kind to facilitate a printing & shipping services market report. By this, upon finalization of the poster, the user may easily browse through a periodically updated report on current printing and shipping services worldwide. Based upon their location and the location where the user wants the poster delivered, the user may choose the best features or price and submit the poster via the web to the corresponding service for print and delivery in the event hall at the given date and time as defined during the submission process.

One of the many advantages of the disclosed system is that, provided the content already exists, a user may easily create the poster within minutes. Furthermore, the user may easily share a version of the poster with colleagues for collaborative work. Last but not least, the user may take the content with them to the event the user is planning to attend and print the poster there, using one of the provided printing services to print the final version of the poster.

In still other preferred embodiments, provided are methods, systems, and related computer program products for the purpose of printing, displaying or disseminating its contents that substantially complies with a set of rules and guidelines regarding any combination or all of the following characteristics of the document: its size when printed or displayed, appearance, format, number of sections, titles of sections, positions of sections, author information formatting, number of columns, number and type of images, tables, graphs, figures, bibliographic references, hyperlinks to online or stored additional content that is referenced by the document, multimedia material such as video or audio that is embedded in the document and all related typesetting information of such objects such as caption size, color, font and location for images, tables, graphs, figures, the method comprising: receiving all such relevant rules, guidelines or restrictions for the creation of the document from an external source and storing them; receiving by the user the document material, comprised by any or all of related text, images, tables, graphs, figures, bibliographic references, hyperlinks, multimedia material and captions; composing the document by combining the document rules, guidelines or restrictions with the user-provided document material in a multitude of ways that offer substantially best quality for the printed or displayed document under the given rules, guidelines or restrictions; such quality being measured in terms of uniformity of text and other document material over the entire area of the document, text line spacing, ability to read and comprehend the document's content from a certain viewing distance either for printed or electronically displayed output; displaying the output of the process on an electronic display or via printing process and allowing the user to modify one or more from a multitude of parameters that control the quality and appearance of the document, such parameters including text font size, text font type, font parameters such as bold, underline, italic, superscript or subscript, positioning of document material in a multitude of ways on the document area such as text followed by image, image followed by text, image to the left or to the right of text, arrangement of various sections in one, two, three, four or more vertical columns or horizontal sections, background image, logo or watermark; such modifications being compared against the set of rules, guidelines or restrictions for compliance and issuing proper user warnings or disallowing the changes that violate them; for each allowable user modification, displaying the output of the process when taking such modifications into account and allowing the user to further modify the document until a substantially optimal result has been obtained; and saving the final document with all associated typesetting information for future retrieval. Optionally, the user can choose from a list the printing facility that can accept the final document for printing and transmitting it in a manner that is substantially secure. Such document, upon being printed, can be optionally mailed for presentation to a venue such as a show, conference or seminar. The saved document can optionally be converted to a number of digital formats, such as PDF, SVG, EPS, HTML, XML, RTF, JPEG, BMP, PNG, GIF, TIFF, Word doc, ODF, RTF, TEX, TXT, MIF, PCL, and transmitted electronically to the location where it will be presented, such as a show, conference or seminar. Optionally, the document can be displayed at a venue by using electronic displays, such as LCD screens, plasma screens, CRT displays, high-power billboard lights, and illuminated rolling films.

In still other preferred embodiments, provided are methods, systems, and related computer program products for representing the set of rules, guidelines and restrictions imposed in the creation of a document in a computer-storable format that can be subsequently stored or disseminated and used according to the methods of the preceding paragraph. In still other preferred embodiments, provided are methods, systems, and related computer program products for implementing the methods of the preceding paragraph in which a user interface provides such functionalities via a series of computer instructions on a computing device, such as a single processor or multiprocessor machine that can include an addressable storage medium such as random access memory (RAM), an electronically erasable programmable read-only memory (EEPROM), masked read-only memory, one time programmable memory, hard disks, floppy disks, laser disk players, digital video devices, compact disks (CDs), Digital Versatile Disks (DVDs), Blue-ray disks, other optical media, video tapes, audio tapes, magnetic recording tracks, electronic networks, and other techniques to transmit or store electronic content such as, by way of example, programs and data. The computer executes an appropriate operating system such as Linux, Unix, MICROSOFT® WINDOWS® 95, MICROSOFT® WINDOWS® 98, MICROSOFT® WINDOWS® NT, MICROSOFT® WINDOWS® VISTA®, MICROSOFT® WINDOWS® XP®, MICROSOFT WINDOWS® 7, APPLE® MACOS®, IBM® OS/2®, and the like. The computer may advantageously be equipped with a network communication device such as a network interface card, a modem, or other network connection device suitable for connecting to one or more networks. Optionally, the system is provided with lists of available rules, guidelines and restrictions for creating a multitude of documents, such as newspaper articles or advertisements, scientific journal articles, magazines, posters presented in conferences, trade-show presentations, digital signage, billboard advertisements, and seminar materials.

In still other preferred embodiments, provided are methods, systems, and related computer program products that accept documents created by methods described in one or more of the preceding paragraphs, or another method of document creation, stores them electronically, magnetically or optically and checks its compliance with a certain set of rules, guidelines or restrictions, including the steps of accepting documents via network (wired or wireless), optical media, magnetic media, digital storage memories such as USB and SD memories, and temporarily storing them internally, accepting the set of rules, guidelines or restrictions via the one of the methods presented in one or more of the preceding paragraphs, or a substantially similar method, and applying a series of steps to check validity of transmitted content in terms of the desired set of rules, guidelines or restrictions. Optionally, the user can be warned about any item in the submitted document that may not be compatible. Optionally, suggestions can be offered, in the form of a list of options, regarding how to fix the problems detected. Optionally, a number of alternatives can be presented on how the submitted content can be improved in terms of visual quality by the suggested modifications. Optionally, the user can be allowed to provide input regarding acceptance or possible further modification of the submitted document. The final document can be stored in a number of available formats. Optionally, the user is provided the ability to choose from a list the printing facility that can accept the final document for printing and transmitting it in a manner that is substantially secure. Such document, upon being printed, can be optionally mailed for presentation to a venue such as a show, conference or seminar. Optionally, the saved document can be converted to a number of digital formats, such as PDF, SVG, EPS, HTML, XML, RTF, JPEG, BMP, PNG, GIF, TIFF, WORD®, ODF, RTF, TEX, TXT, MIF, PCL, EMF, WMF, and transmitted electronically to the location where it will be presented, such as a show, conference or seminar. Optionally, the document can be displayed at a venue by using electronic displays, such as LCD screens, plasma screens, CRT displays, high-power billboard lights, and illuminated rolling films.

In still other preferred embodiments, provided are methods, systems, and related computer program products that accept documents created by methods described in one or more of the preceding paragraphs, and presents these documents in a venue through the use of electronic displays, such as LCD screens, plasma screens, CRT displays, high-power billboard lights, or illuminated rolling films in an optionally predetermined location, at an optionally predetermined time and with optionally predetermined features such as duration of display, intensity and color tone of the display device. Optionally, the display device can offer a user-input device such as a keyboard, mouse, trackball, joystick, voice-activated control, gesture-activated camera or the like that can optionally modify the appearance of the displayed document, such as commencing or stopping playback of a video clip embedded in the document.

Whereas many alterations and modifications of the embodiments will no doubt become apparent to a person of ordinary skill in the art after having read the foregoing description, it is to be understood that the particular embodiments shown and described by way of illustration are in no way intended to be considered limiting. Thus, reference to the details of the described embodiments are not intended to limit their scope, which is limited only by the scope of the claims set forth below.

What is claimed is:

1. A method for facilitating the generation of a document to be viewed by a community of human viewers in association with a hosted event, the generated document satisfying a set of document configuration guidelines previously established for that hosted event, the method comprising:
identifying a population of hosted events in association with which documents are to be viewed by a respective community of human viewers, each said hosted event having associated therewith a defined set of document configuration guidelines as set forth in a prepared guidelines document;
for each said identified hosted event, accessing and processing the associated prepared guidelines document to generate therefrom a document configuration rules information object, wherein the document configuration rules information object for each of the population of identified hosted events conforms to a common document configuration rules format;
forming a document configuration rules database including the information from each of said document configuration rules information objects;
providing to a user a computerized interactive document generation tool that processes at least one of user-pasted and user-identified content data to generate a digital document therefrom according to the steps of:
displaying to the user a plurality of event identifiers corresponding to respective ones of said hosted events;
receiving from the user a selection of one of said event identifiers corresponding to a selected hosted event for which document generation is desired;
accessing from said document configuration rules database the document configuration rules information object corresponding to the selected hosted event; and
automatically processing said content data to generate therefrom the digital document according to said document configuration rules information object such that a configuration of the digital document is in conformance with the defined set of document configuration guidelines for the selected hosted event.

2. The method of claim 1, wherein said document to be viewed by the community of human viewers is a scientific poster, wherein each of the identified population of hosted events is a scientific conference, and wherein at least two of the associated population of prepared guidelines documents are set forth in substantially different arrangements of human-readable information.

3. The method of claim 2, wherein said population of prepared guidelines documents are stored in electronic form at a respective population of internet-accessible network locations, and wherein said processing of the population of prepared guidelines documents into the respective population of commonly formatted document configuration rules information objects is performed automatically.

4. The method of claim 3, wherein said accessing the prepared guidelines documents is performed in an automated internet crawling process.

5. The method of claim 2, wherein said providing the computerized interactive document generation tool further comprises the steps of:
extracting from said document configuration rules information object information that governs the scientific poster to be generated according to content type, content section constraints, content section sequence, content spatial layout, and content formatting;
displaying to the user a plurality of content section input frames corresponding to a respective plurality of content sections specified by said content section constraints, said plurality of content section input frames being sequenced according to said content section sequence;
separately receiving at least one of user-pasted and user-identified content data into respective ones of said content section input frames, whereby the user is functionally obligated to abide by the content section constraints and content section sequence specified in said document configuration rules information object when so providing the at least one of user-pasted and user-identified content data; and
automatically processing the received content data to generate therefrom the scientific poster according to the content type, content section constraints, content section sequence, content spatial layout, and content formatting specified in the document configuration rules information object.

6. The method of claim 5, wherein said content sections specified by said content section constraints are selected from the group consisting of: Abstract; Introduction; Scope; Experimental; Experimental Methods; Methods; Materials and Methods; Methodology; Results; Results and Discussion; Discussion; Conclusions; References; Literature Cited; and Acknowledgements.

7. The method of claim 1, wherein each of said hosted events is selected from the group consisting of: one-time scientific conferences; periodically held scientific conferences; one-time conferences other than scientific conferences; periodically held conferences other than scientific conferences; one-time media publications; periodic media publications; and ongoing media publications.

8. The method of claim 1, wherein said document is selected from the group consisting of: printed posters; electronic posters; pamphlets; brochures; printed items for distribution; and electronic media objects.

9. A computer-implemented method for facilitating the generation of a document, the document to be viewed by human viewers, comprising:
(a) displaying to a user a plurality of document configuration guideline identifiers corresponding to a respective plurality of predefined document configuration guidelines;
(b) receiving from the user a selection of one of said document configuration guideline identifiers to thereby identify a selected one of said predefined document configuration guidelines;
(c) receiving from the user at least one of user-pasted and user-identified content data upon which the document is to be based, wherein said content data comprises at least one digital media gallery and at least one text segment;
(d) receiving from the user an identified set of bounded regions within which said content data is to be spatially distributed on the document;
(e) establishing a minimum document viewing distance parameter by virtue of one of (i) user input, (ii) the selected predefined document configuration guidelines, and (iii) a default minimum document viewing distance parameter; and
(f) automatically processing said content data to generate therefrom the document in digital form, wherein said processing comprises:
sizing the text of the at least one text segment such that (i) said text is readable at said established minimum viewing distance, (ii) said text section is fully spatially contained within said identified set of bounded regions, and (iii) said selected predefined document configuration guidelines are otherwise met; and
spatially sizing the at least one digital media gallery to occupy as large a spatial area as possible on the document while also being (i) constrained to one of said identified set of bounded regions, (ii) constrained within that bounded region to accommodate any of said text segment identified to be positioned in that bounded region, and (iii) said selected predefined document configuration guidelines are otherwise met.

10. The method of claim 9, wherein said identified set of bounded regions consists of columns, and wherein said receiving from the user an identified set of bounded regions comprises receiving a number of columns across which said content data is to be spatially distributed across the document.

11. The method of claim 9, wherein said media object gallery comprises at least one media object selected from the group consisting of: digital images; digital videos; digital audio information; and interactive display windows.

12. The method of claim 9, further comprising:
extracting from said selected predefined document configuration guidelines information that governs the document to be generated according to content type, content section constraints, content section sequence, content spatial layout, and content formatting;
displaying to the user a plurality of content section input frames corresponding to a respective plurality of content sections specified by said content section constraints, said plurality of content section input frames being sequenced according to said content section sequence;
separately receiving at least one of user-pasted and user-identified content data into respective ones of said content section input frames, whereby the user is functionally obligated to abide by the content section constraints and content section sequence specified in said document configuration rules information object when so providing the at least one of user-pasted and user-identified content data; and
automatically processing the received content data to generate therefrom the document in digital form according to the content type, content section constraints, content section sequence, content spatial layout, and content formatting specified in the selected predefined document configuration guidelines.

13. The method of claim 12, wherein said document is a scientific poster, and wherein said content sections specified by said content section constraints are selected from the group consisting of: Abstract; Introduction; Scope; Experimental; Experimental Methods; Methods; Materials and Methods; Methodology; Results; Results and Discussion; Discussion; Conclusions; References; Literature Cited; and Acknowledgements.

14. The method of claim 12, wherein said content types are specified to include text and media objects, said media objects being selected from the group consisting of digital images, digital videos, and interactive display windows; wherein said content spatial layout specifications include content sizing specifications and content placement specifications; and wherein said content formatting specifications include text style specifications, text spacing specifications, text justification specifications, and background style.

15. The method of claim 9, wherein said document is selected from the group consisting of: printed posters; electronic posters; pamphlets; brochures; printed items for distribution; and electronic media objects.

16. A computer-implemented method for facilitating the generation of a document, the document to be displayed to a population of human viewers at different viewing distances including a first viewing distance interval, the method comprising:
(a) receiving from a user at least one of user-pasted and user-identified content data upon which the document is to be based, wherein said content data includes at least one text segment;
(b) establishing a spatial area of the document to be created based at least in part upon at least one of user input and a selected predefined document configuration guideline;
(c) automatically processing said content data to generate therefrom the document in digital form, including automatically determining a font size for said at least one text segment such that said content data is spatially contained within said established document area while maintaining conformance of said document with said predefined document configuration guideline;
(d) providing at least one user interface tool that receives optional user adjustments affecting said font size, whereby a current font size for said digital document is established;
(e) automatically determining, in real time upon said establishment of said current font size, an optimal document viewing distance based on said current font size; and
(f) displaying in real time said automatically determined optimal document viewing distance to the user in conjunction with a real time indicator identifying whether said automatically determined optimal viewing distance falls within a predetermined first viewing distance range.

17. The method of claim 16, wherein said predetermined first viewing distance range is user-adjustable.

18. The method of claim 16, wherein said predetermined first viewing distance range is based upon information specified in said predefined document configuration guideline.

19. The method of claim 16, wherein said real time indication is selected from the group consisting of: a color-coded visual indicator commonly positioned with said display of said optimal document viewing distance; an audible indicator; and a haptic feedback indicator.

20. The method of claim 16, wherein said predetermined first viewing distance range is one of a plurality of different predetermined viewing distance ranges, and wherein said real time indicator further identifies into which of said plurality of predetermined viewing distance ranges said automatically determined optimal viewing distance falls.

21. The method of claim 16, wherein said automatically determining an optimal document viewing distance comprises:
accessing a first data object that expresses a relationship between font size and a statistically determined optimal viewing distance corresponding thereto; and
processing said current font size according to said first data object.

22. The method of claim 21, wherein said first data object is a lookup table embodying optimal viewing distance data empirically acquired based on a population of human test subjects and a population of documents having text segments with different predetermined font sizes, said empirical acquisition including receiving measurements from each test subject regarding viewing distances that are both (i) too far for comfortably and effectively reading a text segment having a particular font size, and (ii) too close for comfortably and effectively reading that text segment having that particular font size.

23. The method of claim 16, further comprising:
extracting from said selected predefined document configuration guidelines information that governs the document to be generated according to content type, content section constraints, content section sequence, content spatial layout, and content formatting;
displaying to the user a plurality of content section input frames corresponding to a respective plurality of content sections specified by said content section constraints, said plurality of content section input frames being sequenced according to said content section sequence;
wherein said receiving from the user at least one of user-pasted and user-identified content data comprises separately receiving that content data into respective ones of said content section input frames, whereby the user is functionally obligated to abide by the content section constraints and content section sequence specified in said document configuration rules information object when providing that content data; and
wherein said automatically generated document in digital form conforms to the content type, content section constraints, content section sequence, content spatial layout, and content formatting specified in the selected predefined document configuration guidelines.

24. A computer-implemented method for execution by a hosting server associated with a hosted event at which a plurality of electronic media items are to be displayed in a respective plurality of electronic media item presentation sessions, each electronic media item presentation session to take place at one of a plurality of distinct media presentation stations provided in association with the hosted event, the method comprising:
receiving and storing each of the plurality of electronic media items to be displayed;
receiving scheduling information indicating, for each of said electronic media item presentation sessions, a designated time interval therefor and a designated one of the media presentation stations at which the associated electronic media item is to be displayed; and
for each of said electronic media item presentation sessions, causing the associated electronic media item be displayed at the designated media presentation station during the designated time interval.

25. The method of claim 24, wherein each of said media presentation stations includes an electronic display device, and wherein said electronic media items each comprise one or more of digital image information, digital video information, digital audio information, and interactive program information.

26. The method of claim 24, wherein said hosted event is a scientific conference, wherein each said electronic media item includes at least one electronic scientific poster, and wherein each of said media presentation stations includes at least one large format electronic display that displays a rendering of the at least one electronic scientific poster during the associated electronic media item presentation session.

27. The method of claim 26, each said electronic media item further including at least one metadata object associated with a presenter of said at least one electronic scientific poster, the method further including causing the media presentation station to permit presenter interaction with the at least one metadata object therethrough during said electronic media item presentation session.

28. A computer-implemented method for execution by a computing device including a computerized user interface having a clipboard feature, the method for facilitating the generation of a poster, the poster to be viewed by a community of human viewers in association with a hosted conference, the poster to be based at least in part on information contained in an antecedent electronic document from which blocks of information are to be pasted into the poster, the antecedent electronic document comprising (a) a first data block listing a plurality of author names, (b) a second data block listing a plurality of affiliations, (c) a plurality of intermediate characters not part of author names or affiliation names distributed among said first and second data blocks from which can be identified associations among the authors and the affiliations, the poster to conform to poster configuration guidelines previously established for that hosted conference in which the plurality of author names and affiliations are to be visually expressed in a different configuration than as provided in said first and second data blocks of said antecedent electronic document, the method comprising:
displaying to a user a first paste control that at least partially keys the user to access the antecedent electronic document and to copy the first data block into a clipboard;
receiving from the user a selection of said first paste control and, responsive thereto, receiving the first data block from the clipboard and processing the first block to distinctively identify therefrom the plurality of author names;
displaying to the user a second paste control that at least partially keys the user to access the antecedent electronic document and to copy the second data block into the clipboard;
receiving from the user a selection of said second paste control and, responsive thereto, receiving the second data block from the clipboard and processing the second data block to distinctively identify therefrom the plurality of affiliations, and jointly processing the first data block and the second data block including said intermediate characters to distinctively identify therefrom the association, if any, between each distinctively identified author name and each distinctively identified affiliation; and
automatically generating said visual expression of said author names and affiliations according to said poster configuration guidelines based on said distinctively identified author names, said distinctively identified affiliations, and said distinctively identified author-affiliation associations.

29. The method of claim 28, further comprising:
responsive to the user selection of said first paste control, displaying a listing of author names ordered according to an order of their appearance in said first data block;
responsive to the user selection of said second paste control, displaying a listing of affiliations near said listing of author names such that the one or more affiliations associated with each author name appear in visual correspondence with that author name.

30. The method of claim 29, wherein said listings of authors and affiliations are displayed in table format, and wherein said table is editable by the user.

31. The method of claim 28, wherein said distinctively identifying the plurality of author names comprises detecting any professional identifiers included with each author name, and wherein said distinctively identifying said associations comprises (i) identifying intermediate characters in said first data block as characters therein other than those corresponding to author names including the professional identifiers, (ii) identifying the intermediate characters in said second data block as characters therein other than those corresponding to affiliations, and (iii) processing said identified intermediate characters in said first and second data blocks to determine relationships between said author names and said affiliations.

32. The method of claim 28, further comprising:
extracting from said poster configuration guidelines information that governs the poster to be generated according to content type, content section constraints, content section sequence, content spatial layout, and content formatting;
displaying to the user a plurality of content section input frames corresponding to a respective plurality of content sections specified by said content section constraints, said plurality of content section input frames being sequenced according to said content section sequence;
receiving from the user blocks of content data cut from the antecedent electronic document by operation of said clipboard feature and pasted into respective ones of said content section input frames, whereby the user is functionally obligated to abide by the content section constraints and content section sequence specified in said poster configuration guidelines; and
automatically processing the received content data to generate therefrom the poster in digital form according to the content type, content section constraints, content section sequence, content spatial layout, and content formatting specified in said poster configuration guidelines.

33. The method of claim 32, wherein said poster is a scientific poster, and wherein said content sections specified by said content section constraints are selected from the group consisting of: Abstract; Introduction; Scope; Experimental; Experimental Methods; Methods; Materials and Methods; Methodology; Results; Results and Discussion; Discussion; Conclusions; References; Literature Cited; and Acknowledgements.

34. The method of claim 32, wherein said content types are specified to include text and media objects, said media objects being selected from the group consisting of digital images, digital videos, and interactive display windows; wherein said content spatial layout specifications include content sizing specifications and content placement specifications; and wherein said content formatting specifications include text style specifications, text spacing specifications, text spacing specifications, text justification specifications, and background style.

35. A method for facilitating the generation of a poster to be viewed by a community of human viewers in association with a hosted event, the poster satisfying a poster configuration guideline previously established for that hosted event, the method comprising:
providing a poster configuration rules database including a plurality of poster configuration rules information objects corresponding respectively to a population of hosted events, each poster configuration rules information object being created from a respective one of said poster configuration guidelines and conforming to a common poster configuration rules format, wherein each poster configuration rules information object governs the corresponding poster to be generated according to content type, content section constraints, content section sequence, content spatial layout, and content formatting;
receiving from a user an identity of said hosted event;
accessing from said poster configuration rules database a poster configuration rules information object corresponding to said hosted event;
displaying to the user a plurality of content section input frames corresponding to a respective plurality of content sections specified by said content section constraints of said poster configuration rules information object, said plurality of content section input frames being sequenced according to said content section sequence of said poster configuration rules information object;
receiving respective blocks of one of user-pasted and user-identified content data into respective ones of said content section input frames, said respective blocks of content data each including at least one media object and least one text segment;
automatically processing the received content data to generate therefrom the poster according to the content type, content section constraints, content section sequence, content spatial layout, and content formatting specified in the poster configuration rules information object;
responsive to a first user request, rendering the poster in real time and displaying a viewable version thereof scaled to fit onto a predefined display area;
responsive to a second user request, automatically reformatting the content data to facilitate a guided user navigation through the poster content on at least one of a section-by-section basis and media object-by-media object basis; and
responsive to a third user request, automatically reformatting the content data to generate therefrom a small-scale version of the poster content suitable for printout and distribution to said community of human viewers.

36. The method of claim 35, further comprising, responsive to a fourth user request, automatically reformatting the content data to generate therefrom a web site featuring the content data, the web site including a hyperlink structure based at least on part on said content section constraints specified in the poster configuration rules information object.

37. The method of claim 35, wherein said poster is a scientific poster, and wherein said content sections specified by said content section constraints are selected from the group consisting of: Abstract; Introduction; Scope; Experimental; Experimental Methods; Methods; Materials and Methods; Methodology; Results; Results and Discussion; Discussion; Conclusions; References; Literature Cited; and Acknowledgements.

38. The method of claim 35, wherein said content types are specified to include text and media objects, said media objects being selected from the group consisting of digital images, digital videos, and interactive display windows; wherein said content spatial layout specifications include content sizing specifications and content placement specifications; and wherein said content formatting specifications include text style specifications, text spacing specifications, text spacing specifications, text justification specifications, and background style.

39. A method for facilitating the generation of a plurality of documents to be viewed by respective communities of human viewers in association with a respective plurality of hosted events, each document satisfying a respective document configuration guideline previously established for the respective plurality of hosted events, the method comprising:
providing a document configuration rules database including a plurality of document configuration rules information objects corresponding respectively to said plurality of hosted events, each document configuration rules information object being created from a respective one of said document configuration guidelines and conforming to a common document configuration rules format, wherein each document configuration rules information object governs the corresponding document to be generated according to content type, content section constraints, content section sequence, content spatial layout, and content formatting;
receiving from a user an identity of a first of said plurality of hosted events;
accessing from said document configuration rules database a first document configuration rules information object corresponding to said first hosted event;
displaying to the user a plurality of content section input frames corresponding to a respective plurality of content sections specified by said content section constraints of said first document configuration rules information object, said plurality of content section input frames being sequenced according to said content section sequence of said first document configuration rules information object;
receiving respective blocks of one of user-pasted and user-identified content data into respective ones of said content section input frames; and
automatically processing the received content data to generate therefrom the first document according to the content type, content section constraints, content section sequence, content spatial layout, and content formatting specified in the first document configuration rules information object;
storing said first document;
receiving from the user an identity of a second of said plurality of hosted events;
accessing from said document configuration rules database a second document configuration rules information object corresponding to said second hosted event;
retrieving said first document;
automatically processing said retrieved first document to generate therefrom the second document according to the content type, content section constraints, content section sequence, content spatial layout, and content formatting specified in the second document configuration rules information object;
whereby the user effort associated with creation of said second document is substantially less than the user effort associated with creation of said first document.

40. The method of claim 39, further comprising:
receiving from the user an identity of a third of said plurality of hosted events;
accessing from said document configuration rules database a third document configuration rules information object corresponding to said third hosted event;
automatically processing at least one of said first and second documents to generate therefrom the third document according to the content type, content section constraints, content section sequence, content spatial layout, and content formatting specified in the third document configuration rules information object.

41. The method of claim 39, wherein each of said hosted events is selected from the group consisting of: one-time scientific conferences; periodically held scientific conferences; one-time conferences other than scientific conferences; periodically held conferences other than scientific conferences; one-time media publications; periodic media publications; and ongoing media publications.

42. The method of claim 39, wherein said document is selected from the group consisting of: printed posters; electronic posters; pamphlets; brochures; printed items for distribution; and electronic media objects.
